(19) United States
(12) Patent Application Publication
(10) Pub. No.: US 2025/0315280 A1
(43) Pub. Date: Oct. 9, 2025

(54) APPLICATION WINDOW PROCESSING METHOD AND RELATED DEVICE

(71) Applicant: Huawei Technologies Co., Ltd., Shenzhen (CN)

(72) Inventor: Yunjing Zhao, Shenzhen (CN)

(21) Appl. No.: 19/246,331

(22) Filed: Jun. 23, 2025

Related U.S. Application Data
(63) Continuation of application No. PCT/CN2024/092987, filed on May 14, 2024.

(30) Foreign Application Priority Data
May 15, 2023 (CN) 202310547087.3

(51) Int. Cl. G06F 9/451; G06F 3/0484; G06F 3/04886; G06F 3/0489

(52) U.S. Cl. CPC G06F 9/451; G06F 3/0484; G06F 3/04886; G06F 3/0489; G06F 2203/04803

(57) ABSTRACT

A method is applied to an electronic device. The electronic device includes a first display screen. The method includes: displaying a control of at least one first application window at a top of the first display screen, where the top of the first display screen is a region that is in the first display screen and that is close to a second display screen, and each first application window is in an enabled state on the first display screen or the second display screen; and obtaining a first operation by using the control of the first application window, and determining a second operation for the first application window in response to the first operation.

### CROSS-REFERENCE TO RELATED APPLICATIONS

This application is a continuation of International Application No. PCT/CN2024/092987, filed on May 14, 2024, which claims priority to Chinese Patent Application No. 202310547087.3, filed on May 15, 2023. The disclosures of the aforementioned applications are hereby incorporated by reference in their entireties.

### TECHNICAL FIELD

This application relates to the field of computer technologies, and in particular, to an application window processing method and a related device.

### BACKGROUND ART

With emergence of foldable screen devices, to provide a larger screen display area for a user, a region originally used to place a physical keyboard and a touchpad now may also be used to display an application window.

Because the physical touchpad is removed, the user may raise a hand to tap a second display screen, to input a control operation for an application window on the second display screen. However, frequent hand raising actions not only cause fatigue to the user, but also may cause the second display screen to shake or even tip over when the second display screen is tapped.

### SUMMARY

Embodiments of this application provide an application window processing method and a related device. A user may input an operation for an application window by using a control of a first application window located at a top of a first display screen, and the user does not need to raise a hand to tap a second display screen. This not only avoids fatigue of the user, but also avoids shaking or even tip-over of the second display screen. In addition, because the control of the application window is disposed at the top of the first display screen, the user can see the control of the application window without a need to lower the head, thereby avoiding burden on the cervical vertebra of the user, and helping further enhance user viscosity of this solution.

To resolve the foregoing technical problem, embodiments of this application provide the following technical solutions.

According to a first aspect, an embodiment of this application provides an application window processing method, which may be applied to a human-computer interaction field. The method is applied to an electronic device, the electronic device includes a first display screen, and the method includes: The electronic device displays a control of each first application window in at least one first application window at a top of the first display screen, where the top of the first display screen is a region that is in the first display screen and that is close to a second display screen, and each first application window is in an enabled state on the first display screen or the second display screen. The first application window being in an enabled state on the first display screen or the second display screen includes the following: The first application window is displayed on the first display screen, the first application window is displayed on the second display screen, the first application window is in a collapsed state on the first display screen, or the first application window is in a collapsed state on the second display screen. For example, if an application window in an enabled state exists only on the second display screen, the “at least one first application window” may include all application windows in an enabled state on the second display screen; if an application window in an enabled state exists only on the first display screen, the “at least one first application window” may include all application windows in an enabled state on the first display screen; or if an application window in an enabled state exists both on the first display screen and the second display screen, the “at least one first application window” may include all application windows in an enabled state on the first display screen and all application windows in an enabled state on the second display screen.

The electronic device obtains a first operation by using the control of the first application window, that is, the first operation is input by a user by using the control in the first application window. In response to the first operation, the electronic device determines a second operation for the first application window. In this implementation, the control of each application window is displayed at the top of the first display screen, and the user input an operation for the application window by using the control of the first application window located at the top of the first display screen, and the user does not need to raise a hand to tap the second display screen. This not only avoids fatigue of the user, but also avoids shaking or even tip-over of the second display screen. In addition, because the control of the application window is disposed at the top of the first display screen, the user can see the control of the application window without a need to lower the head, thereby avoiding burden on the cervical vertebra of the user, and helping further enhance user viscosity of this solution.

In a possible implementation, when the control of the at least one first application window and an input control are displayed on the first display screen, the control of the at least one first application window is located on an upper side of the input control, and the input control includes a keyboard and/or a touchpad. In this implementation, when the first application window is controlled by using the control of the first application window displayed on the first display screen, the keyboard and/or the touchpad may also be conveniently used. In addition, because the control of the first application window is located on the upper side of the input control, it is not easy to cause an accidental touch on the control of the first application window in a process of using the keyboard and/or the touchpad.

In a possible implementation, in a process of switching the input control between a plurality of display modes, automatic adjustment of an area occupied by the control of the at least one first application window can be triggered, that is, a factor that triggers adjustment of the area occupied by the control of the at least one first application window includes: the input control is switched between a first display mode and a second display mode. Both the keyboard and the touchpad are displayed in the first display mode, with the touchpad on an upper side or a lower side of the keyboard, and the second display mode is any one of the following plurality of display modes: displaying a thumbnail of the touchpad and the keyboard, displaying a thumbnail of the keyboard and the touchpad, or displaying both the keyboard and the touchpad, with the touchpad on a left side or a right side of the keyboard.

Optionally, when a display mode of the input control is the second display mode, the control of the at least one first application window may use a first expanded state. When the display mode of the input control is the first display mode, the control of the at least one first application window may use a second expanded state. An area occupied by the control of the at least one first application window in the first expanded state is greater than an area occupied by the control of the at least one first application window in the second expanded state.

In this implementation, because a width of the second display screen is fixed, when both the keyboard and the touchpad are displayed, and the touchpad is displayed on the upper side or the lower side of the keyboard, widths of the touchpad and the keyboard are compressed. In this case, the area occupied by the control of the at least one first application window is automatically reduced, so that the touchpad and the keyboard are wider, and user experience of using the touchpad and the keyboard is improved. When the touchpad and the keyboard are no longer displayed in upper and lower positions, the widths of the touchpad and the keyboard are no longer compressed. In this case, the area occupied by the control of the at least one first application window is automatically enlarged, which helps enhance user experience of the control of the first application window. That is, by using the foregoing solution, the area occupied by the control of the first application window can be automatically adjusted with reference to an actual scenario, which helps enhance user experience.

In a possible implementation, a mode of displaying the input control on the first display screen includes any one or more of the following: displaying the thumbnail of the touchpad and the keyboard; displaying the thumbnail of the keyboard and the touchpad; displaying the thumbnail of the touchpad and the thumbnail of the keyboard; displaying both the keyboard and the touchpad, with the touchpad on a left side or a right side of the keyboard; or displaying both the keyboard and the touchpad, with the touchpad on the upper side or the lower side of the keyboard. In this implementation, the plurality of display modes of the keyboard and the touchpad are provided, which helps adapt to various application scenarios and improves implementation flexibility of this solution.

In a possible implementation, when the control of the at least one first application window is in a first displayed state, the control of the first application window includes a thumbnail of the first application window and/or a first icon of an application program corresponding to the first application window. “The application program corresponding to the first application window” may also be understood as “the first application window is started in the application program”, or may be understood as “the first application program comes from the application program”, or the like.

For example, that the control of the first application window is in the first displayed state may also be understood as that the first application window is in an expanded state. Optionally, the first displayed state may include a first expanded state and a second expanded state.

In this implementation, the control of each first application window uses the thumbnail of the first application window and/or the icon of the application program corresponding to the first application window. Therefore, the user may intuitively learn, based on the displayed control of each first application window, that each control is used to obtain a control operation of which application window, thereby further improving convenience of the user in a process of controlling the application window.

In a possible implementation, when the control of the at least one first application window is in a second displayed state, a second icon corresponding to the control of the at least one first application window is displayed on the first display screen, the second icon is used to obtain a third operation, and the third operation is used to switch the control of the at least one first application window from the second displayed state to the first displayed state. For example, that the control of the first application window is in the second displayed state may be understood as that the first application window is in a collapsed state.

In this implementation, when the control of the at least one first application window is in the second displayed state, controls of all first application windows are presented as one second icon, and areas occupied by the controls of all the first application windows are smaller. Therefore, when the control of the first application window does not need to be used, the control of the first application window can be collapsed, so as to prevent the control of the first application window from blocking a line of sight of the user, so as to fully utilize the screen of the first display screen. In addition, the second icon is used to obtain a third operation, and the control of the first application window may be switched from the second displayed state back to the first displayed state by using the third operation. Therefore, when the control of the first application window needs to be used, the control of the first application window can be conveniently expanded.

In a possible implementation, when the first application window is displayed on the first display screen, the control of the first application window uses a first display manner, or when the first application window is displayed on the second display screen, the control of the first application window uses a second display manner, where the first display manner is different from the second display manner. For example, a difference between the first display manner and the second display manner may be as follows: A visual display angle of the first display manner is different from a visual display angle of the second display manner, or transparency of the first display manner is different from transparency of the second display manner, or there may be another difference between the first display manner and the second display manner, or the like.

In this implementation, in the two cases in which the first application window is located on the first display screen and the second display screen, the control of the first application window may use different display manners, so that when viewing the control of each first application window, the user can learn whether each first application window is located on the first display screen or the second display screen, thereby helping the user manage the application window more efficiently.

In a possible implementation, when the at least one first application window is displayed on the first display screen, a thumbnail of an input control is displayed on the first display screen, where the input control includes a keyboard and/or a touchpad. In this implementation, when the user views the application window on the first display screen, the input control on the first display screen does not block the line of sight of the user, and the user can conveniently start the input control by using the thumbnail of the input control. This improves flexibility of this solution, and helps enhance user viscosity of this solution.

In a possible implementation, when the user wants to use the keyboard or the touchpad, the user may tap the thumbnail of the keyboard or the thumbnail of the touchpad. Correspondingly, the electronic device can obtain a tap operation on the thumbnail of the keyboard or the thumbnail of the touchpad, to trigger starting of the keyboard or the touchpad, and collapse the first application window displayed on the first display screen.

In a possible implementation, the second operation is any one of the following operations: switching the first application window from being collapsed to being displayed; switching the first application window from being displayed on the first display screen to being displayed on the second display screen; switching the first application window from being displayed on the second display screen to being displayed on the first display screen; adjusting a display position of the first application window on a same display screen; or adjusting a size of the first application window. In this implementation, a plurality of control operations on the first application window can be implemented by using the control of the first application window, and the user can conveniently perform a plurality of operations on the first application window by using the control of the first application window, thereby improving user viscosity of this solution.

In a possible implementation, when the first application window is displayed on the second display screen, and the first operation is a downward slide operation obtained by using the control of the first application window, the second operation is switching the first application window from being displayed on the second display screen to being displayed on the first display screen; or when the first application window is displayed on the first display screen, and the first operation is an upward slide operation obtained by using the control of the first application window, the second operation is switching the first application window from being displayed on the first display screen to being displayed on the second display screen.

In this implementation, the user may implement switching of the first application window between different display screens by inputting an upward slide operation or a downward slide operation on the control of the first application window. The upward slide operation or the downward slide operation is simple, and the foregoing implementation is very efficient.

In a possible implementation, when a first application window is switched from being displayed on the second display screen to being displayed on the first display screen, the control of the at least one first application window may remain unchanged. After the electronic device obtains a fourth operation input by the user, the control of the at least one first application window is triggered to be displayed on the first display screen in the second displayed state. For example, the fourth operation may be that the user inputs a tap operation on a region, in all regions included in the first display screen, different from a region occupied by the control of the at least one first application window. In this implementation, by using the foregoing operation, it can be ensured that a previous operation of the user is not an accidental touch. In addition, if the previous operation is an accidental touch, the user may also perform adjustment in time by using the control of the at least one first application window.

In a possible implementation, when the first operation is a leftward slide operation obtained by using the control of the first application window, the second operation is displaying the first application window in a left region of a current display screen, where the current display screen is a display screen that displays the first application window before the first operation is obtained; or when the first operation is a rightward slide operation obtained by using the control of the first application window, the second operation is displaying the first application window in a right region of the current display screen.

For example, the left region of the current display screen may be understood as a region of a left half display screen of the current display screen, and the right region of the current display screen may be understood as a region of a right half display screen of the current display screen. Then, when the first operation is a leftward slide operation obtained by using the control of the first application window, the second operation may be understood as controlling the first application window to perform screen splitting on a left side. When the first operation is a rightward slide operation obtained by using the control of the first application window, the second operation may be understood as controlling the first application window to perform screen splitting on a right side.

In this implementation, the user may input a leftward slide operation or a rightward slide operation on the control of the first application window, so that a position of the first application window can be adjusted to the left region or the right region of the current display screen. This operation is simple, and the foregoing implementation is very efficient.

In a possible implementation, when the first operation includes obtaining a touch-and-hold operation and a movement gesture by using the control of the first application window, the second operation includes controlling the first application window to perform a movement operation corresponding to the movement gesture. Optionally, a movement direction of the first application window may be consistent with a movement direction of the movement gesture, and a movement distance of the first application window is corresponding to a movement distance of the movement gesture.

In this implementation, after touching and holding the control of the first application window, the user only needs to input a drag gesture on the control of the first application window, so as to control, based on the drag gesture input by the user, the first application window to move. In this way, the user can control, based on a requirement of the user, the first application window to move to any position of the current display screen, thereby greatly improving flexibility of the user in a process of moving the first application window.

In a possible implementation, when the first operation is any one of the following operations: a double-tap operation, a dual-finger pinch operation, or a dual-finger spread operation, the second operation includes controlling the first application window to switch between the following plurality of display manners: displaying the first application window in a maximized manner on a current display screen, where the current display screen is a display screen that displays the first application window before the first operation is obtained; displaying the first application window in a maximized manner on two display screens of the electronic device; or displaying the first application window in a third display manner, where the third display manner is a display manner of the first application window before the first operation is obtained.

In this implementation, when the user inputs a double-tap operation, a dual-finger pinch operation, or a dual-finger spread operation by using the control of the first application window, the first application window can be triggered to switch in three display manners with different sizes, thereby implementing quick and convenient adjustment of the size of the first application window.

In a possible implementation, when the first application window is displayed on the first display screen, and the first operation is a downward slide operation obtained by using the control of the first application window, the second operation is triggering the first application window to be displayed on the first display screen in a pinned state, and that the first application window is displayed on the first display screen in a pinned state represents that when another application window is displayed on the first display screen, the first application window is not collapsed; or when the first application window is displayed on the second display screen, and the first operation is an upward slide operation obtained by using the control of the first application window, the second operation is triggering the first application window to be displayed on the second display screen in a pinned state, and that the first application window is displayed on the second display screen in a pinned state represents that when another application window is displayed on the second display screen, the first application window is not collapsed.

In this implementation, by using the foregoing solution, a plurality of application windows can be displayed on a same display screen, so that a case in which only one application window can be displayed on a same display screen is avoided. To be specific, the user can control the application window more flexibly.

In a possible implementation, if a pinned state of a first application window needs to be canceled, in an implementation, a control of the first application window may be used to control the first application window to switch from being displayed to being collapsed. When the first application window is collapsed, the pinned state of the first application window is automatically canceled. In another implementation, the first application window may be further switched from being displayed on the first display screen to being displayed on the second display screen by using the control of the first application window, or the first application window may be switched from being displayed on the second display screen to being displayed on the first display screen by using the control of the first application window. When a display screen on which the first application window is located changes, the pinned state of the first application window is automatically canceled, and so on.

In a possible implementation, when a desktop of the electronic device is displayed in a maximized manner on two display screens of the electronic device, and the control of the at least one first application window is displayed on the first display screen, at least one icon included on the desktop is located in the second display screen. In this implementation, the at least one icon included on the desktop is located only on the second display screen, thereby avoiding a case in which the icon on the desktop cannot be tapped because the control of the first application window blocks the icon, and ensuring that both the icon on the desktop and the control of the first application window can be normally used.

According to a second aspect, an embodiment of this application provides an application window processing apparatus, which may be applied to the human-computer interaction field; the application window processing apparatus is applied to an electronic device, the electronic device includes a first display screen, and the apparatus includes: a display module, configured to display a control of at least one first application window at a top of the first display screen, where the top of the first display screen is a region that is in the first display screen and that is close to a second display screen, and each first application window is in an enabled state on the first display screen or the second display screen; an obtaining module, configured to obtain a first operation by using the control of the first application window; and a determining module, configured to determine a second operation for the first application window in response to the first operation.

In a possible implementation, when the control of the at least one first application window and an input control are displayed on the first display screen, the control of the at least one first application window is located on an upper side of the input control, and the input control includes a keyboard and/or a touchpad.

In a possible implementation, a factor that triggers adjustment of an area occupied by the control of the at least one first application window includes: the input control is switched between a first display mode and a second display mode; and both the keyboard and the touchpad are displayed in the first display mode, with the touchpad on an upper side or a lower side of the keyboard, and the second display mode is any one of the following plurality of display modes: displaying a thumbnail of the touchpad and the keyboard, displaying a thumbnail of the keyboard and the touchpad, or displaying both the keyboard and the touchpad, with the touchpad on a left side or a right side of the keyboard.

In a possible implementation, a mode of displaying the input control on the first display screen includes any one or more of the following: displaying the thumbnail of the touchpad and the keyboard; displaying the thumbnail of the keyboard and the touchpad; displaying the thumbnail of the touchpad and the thumbnail of the keyboard; displaying both the keyboard and the touchpad, with the touchpad on a left side or a right side of the keyboard; or displaying both the keyboard and the touchpad, with the touchpad on the upper side or the lower side of the keyboard.

In a possible implementation, when the control of the at least one first application window is in a first displayed state, the control of the first application window includes a thumbnail of the first application window and/or a first icon of an application program corresponding to the first application window.

In a possible implementation, when the control of the at least one first application window is in a second displayed state, a second icon corresponding to the control of the at least one first application window is displayed on the first display screen, the second icon is used to obtain a third operation, and the third operation is used to switch the control of the at least one first application window from the second displayed state to the first displayed state.

In a possible implementation, when the first application window is displayed on the first display screen, the control of the first application window uses a first display manner, or when the first application window is displayed on the second display screen, the control of the first application window uses a second display manner, where the first display manner is different from the second display manner.

In a possible implementation, when the at least one first application window is displayed on the first display screen, a thumbnail of an input control is displayed on the first display screen, where the input control includes a keyboard and/or a touchpad.

In a possible implementation, the second operation is any one of the following operations: switching the first application window from being collapsed to being displayed; switching the first application window from being displayed on the first display screen to being displayed on the second display screen; switching the first application window from being displayed on the second display screen to being displayed on the first display screen; adjusting a display position of the first application window on a same display screen; or adjusting a size of the first application window.

In a possible implementation, when the first application window is displayed on the second display screen, and the first operation is a downward slide operation obtained by using the control of the first application window, the second operation is switching the first application window from being displayed on the second display screen to being displayed on the first display screen; or when the first application window is displayed on the first display screen, and the first operation is an upward slide operation obtained by using the control of the first application window, the second operation is switching the first application window from being displayed on the first display screen to being displayed on the second display screen.

In a possible implementation, when the first operation is a leftward slide operation obtained by using the control of the first application window, the second operation is displaying the first application window in a left region of a current display screen, where the current display screen is a display screen that displays the first application window before the first operation is obtained; or when the first operation is a rightward slide operation obtained by using the control of the first application window, the second operation is displaying the first application window in a right region of the current display screen.

In a possible implementation, when the first operation includes obtaining a touch-and-hold operation and a movement gesture by using the control of the first application window, the second operation includes controlling the first application window to perform a movement operation corresponding to the movement gesture.

In a possible implementation, when the first operation is any one of the following operations: a double-tap operation, a dual-finger pinch operation, or a dual-finger spread operation, the second operation includes controlling the first application window to switch between the following plurality of display manners: displaying the first application window in a maximized manner on a current display screen, where the current display screen is a display screen that displays the first application window before the first operation is obtained; displaying the first application window in a maximized manner on two display screens of the electronic device; or displaying the first application window in a third display manner, where the third display manner is a display manner of the first application window before the first operation is obtained.

In a possible implementation, when the first application window is displayed on the first display screen, and the first operation is a downward slide operation obtained by using the control of the first application window, the second operation is triggering the first application window to be displayed on the first display screen in a pinned state, and that the first application window is displayed on the first display screen in a pinned state represents that when another application window is displayed on the first display screen, the first application window is not collapsed; or when the first application window is displayed on the second display screen, and the first operation is an upward slide operation obtained by using the control of the first application window, the second operation is triggering the first application window to be displayed on the second display screen in a pinned state, and that the first application window is displayed on the second display screen in a pinned state represents that when another application window is displayed on the second display screen, the first application window is not collapsed.

In a possible implementation, when a desktop of the electronic device is displayed in a maximized manner on two display screens of the electronic device, and the control of the at least one first application window is displayed on the first display screen, at least one icon included on the desktop is located in the second display screen.

For concepts of the nouns and beneficial effect brought by specific implementation steps in the second aspect and some possible implementations of the second aspect of this embodiment of this application, refer to the description in the possible implementations of the first aspect. Details are not described herein again.

According to a third aspect, an embodiment of this application provides an electronic device, which may be applied to the human-computer interaction field. The electronic device includes a first display screen and one or more processors, the processor is coupled to a memory, the memory stores program instructions, and when the program instructions stored in the memory are executed by the processor, the electronic device is enabled to perform the following steps: displaying a control of at least one first application window at a top of the first display screen, where the top of the first display screen is a region that is in the first display screen and that is close to a second display screen, and each first application window is in an enabled state on the first display screen or the second display screen; and obtaining a first operation by using the control of the first application window, and determining a second operation for the first application window in response to the first operation.

In the third aspect of this embodiment of this application, the electronic device may be further configured to perform steps performed by the electronic device in the possible implementations of the first aspect. For specific implementations of some steps and beneficial effect brought by each possible implementation in the third aspect and the possible implementations of the third aspect of this embodiment of this application, refer to the description in the possible implementations of the first aspect. Details are not described herein again.

According to a fourth aspect, an embodiment of this application provides a computer-readable storage medium. The computer-readable storage medium stores a computer program. When the computer program is run on a computer, the computer is enabled to perform the application window processing method in the first aspect.

According to a fifth aspect, an embodiment of this application provides a computer program product, where the computer program product includes instructions, and when the instructions are run on a computer, the computer is enabled to perform the application window processing method in the first aspect.

According to a sixth aspect, an embodiment of this application provides a chip system. The chip system includes a processor, configured to support the chip in implementing the functions in the first aspect, for example, sending or processing of data and/or information in the foregoing method. In a possible design, the chip system further includes a memory, and the memory is configured to store program instructions and data that are necessary for a server or a communication device. The chip system may include a chip, or may include a chip and another discrete component.

### BRIEF DESCRIPTION OF THE DRAWINGS

FIG. 1 is a diagram of an electronic device according to an embodiment of this application;

FIG. 2 is two diagrams of an electronic device according to an embodiment of this application;

FIG. 3 is a diagram of displaying a control of a first application window at a top of a first display screen according to an embodiment of this application;

FIG. 4 is another diagram of displaying a control of a first application window at a top of a first display screen according to an embodiment of this application;

FIG. 5 is a schematic flowchart of an application window processing method according to an embodiment of this application;

FIG. 6 is two diagrams of a control of at least one first application window according to an embodiment of this application;

FIG. 7 is another diagram of a control of at least one first application window according to an embodiment of this application;

FIG. 8 is a diagram of displaying a control of a first application window and an input control on a first display screen according to an embodiment of this application;

FIG. 9 is a diagram of switching between “displaying a thumbnail of a keyboard and a touchpad” and “displaying a thumbnail of the touchpad and the keyboard” according to an embodiment of this application;

FIG. 10 is a diagram of switching from “displaying a thumbnail of a keyboard and a touchpad” to “displaying both the keyboard and the touchpad, with the touchpad on an upper side of the keyboard” according to an embodiment of this application;

FIG. 11 is a diagram of switching from “displaying a thumbnail of a keyboard and a touchpad” to “displaying both the keyboard and the touchpad, with the touchpad on a left side of the keyboard” according to an embodiment of this application;

FIG. 12 is two diagrams of switching an input control between different display modes according to an embodiment of this application;

FIG. 13 is a diagram of switching an input control between different display modes according to an embodiment of this application;

FIG. 14 is a diagram of adjusting an area occupied by a control of a first application window according to an embodiment of this application;

FIG. 15 is a diagram of switching a target application window between displayed and collapsed by using a control of the target application window according to an embodiment of this application;

FIG. 16 is another diagram of switching a first application window between displayed and collapsed by using a control of the first application window according to an embodiment of this application;

FIG. 17 is a diagram of switching a first application window from collapsed to displayed by using a control of the first application window according to an embodiment of this application;

FIG. 18 is a diagram of switching a first application window from being displayed on a second display screen to being displayed on a first display screen according to an embodiment of this application;

FIG. 19(a) to FIG. 19(e) are diagrams of a control of at least one first application window according to an embodiment of this application;

FIG. 20 is another diagram of a control of at least one first application window according to an embodiment of this application;

FIG. 21 is a diagram of adjusting a position of a first application window according to an embodiment of this application;

FIG. 22 is another diagram of adjusting a position of a first application window according to an embodiment of this application;

FIG. 23 is another diagram of adjusting a position of a first application window according to an embodiment of this application;

FIG. 24 is a diagram of adjusting a size of a first application window according to an embodiment of this application;

FIG. 25 is a diagram of a structure of an application window processing apparatus according to an embodiment of this application; and

FIG. 26 is a diagram of a structure of an electronic device according to an embodiment of this application.

### DETAILED DESCRIPTION OF ILLUSTRATIVE EMBODIMENTS

The following describes embodiments of this application with reference to the accompanying drawings. A person of ordinary skill in the art may learn that, with development of technologies and emergence of a new scenario, the technical solutions provided in embodiments of this application are also applicable to a similar technical problem.

In the specification, claims, and accompanying drawings of this application, the terms “first”, “second”, and the like are intended to distinguish between similar objects but do not necessarily indicate a specific order or sequence. It should be understood that the terms used in such a way are interchangeable in proper circumstances, which is merely a discrimination manner that is used when objects having a same attribute are described in embodiments of this application. In addition, the terms “include”, “contain” and any other variants mean to cover the non-exclusive inclusion, so that a process, method, system, product, or device that includes a series of units is not necessarily limited to those units, but may include other units not expressly listed or inherent to such a process, method, system, product, or device.

A method provided in this application may be applied to an electronic device having two display screens. For example, the method provided in this application may be used to control one or more application windows started in the electronic device.

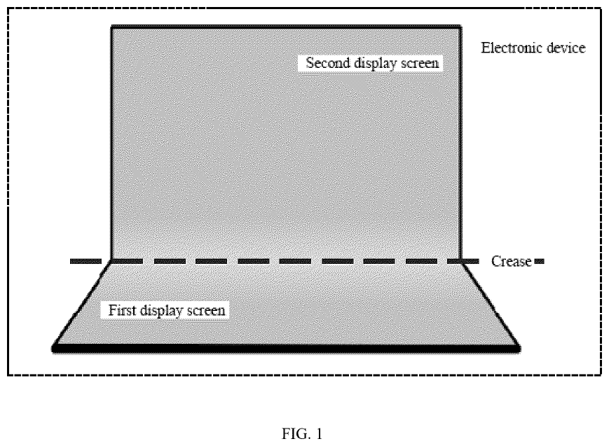

The electronic device may include two display screens, and the two display screens may include a first display screen and a second display screen. In a case, the first display screen and the second display screen may be integrated. For example, the electronic device may be a foldable screen device. When the electronic device is presented in a folded state, a crease exists between the first display screen and the second display screen. For more intuitive understanding of this solution, refer to FIG. 1. FIG. 1 is a diagram of an electronic device according to an embodiment of this application. The electronic device includes a first display screen and a second display screen. The second display screen is located above the first display screen. As shown in FIG. 1, the first display screen may be a lower half display screen of the electronic device, and the second display screen may be an upper half display screen of the electronic device. It should be understood that the example in FIG. 1 is merely for ease of understanding of this solution, and is not intended to limit this solution.

In another case, the first display screen and the second display screen may alternatively be two independent display screens. For example, the first display screen and the second display screen may be connected by using a rotating shaft; or the first display screen and the second display screen are respectively display screens of two independent electronic devices.

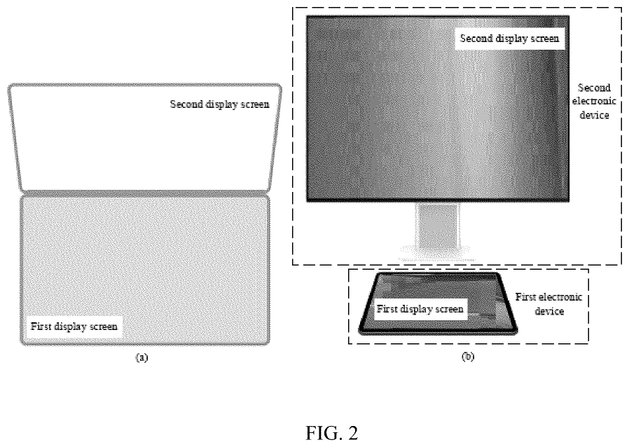

For more intuitive understanding of this solution, refer to FIG. 2. FIG. 2 is two diagrams of an electronic device according to an embodiment of this application. FIG. 2 includes two sub-diagrams (a) and (b). As shown in sub-diagram (a) of FIG. 2, a first display screen and a second display screen are connected by using a rotating shaft, and the second display screen is located above the first display screen.

As shown in sub-diagram (b) of FIG. 2, a display screen of a first electronic device is a first display screen, a display screen of a second electronic device is a second display screen, the second display screen is located above the first display screen, and a communication connection exists between the first electronic device and the second electronic device. It should be understood that the example in FIG. 2 is merely for ease of understanding of this solution, and is not intended to limit this solution.

It should be noted that an electronic device including a first display screen and a second display screen may alternatively be represented in another product form. The foregoing examples are merely for ease of understanding of this solution, and are not intended to limit this solution.

When an application window is displayed on a second display screen, a user may raise a hand to tap the second display screen, to input a control operation for the application window on the second display screen. However, frequent hand raising actions not only cause fatigue to the user, but also may cause the second display screen to shake or even tip over when the second display screen is tapped.

To resolve the foregoing problem, this application provides an application window processing method. Specifically, a control of each first application window may be displayed at a top of a first display screen, the top of the first display screen is a region that is in the first display screen and that is close to a second display screen, and each first application window is in an enabled state on the first display screen or the second display screen. A user may input a first operation by using the control of each first application window. Correspondingly, after obtaining the first operation, an electronic device can determine a second operation corresponding to the first operation. To be specific, the user can input a control operation for each first application window by using the control of the first application window. The user does not need to raise a hand to tap the second display screen, which not only avoids fatigue of the user, but also avoids shaking or even tip-over of the second display screen. In addition, because the control of the first application window is disposed at the top of the first display screen, the user can see the control of the first application window without a need to lower the head, thereby avoiding burden on the cervical vertebra of the user, and helping further enhance user viscosity of this solution.

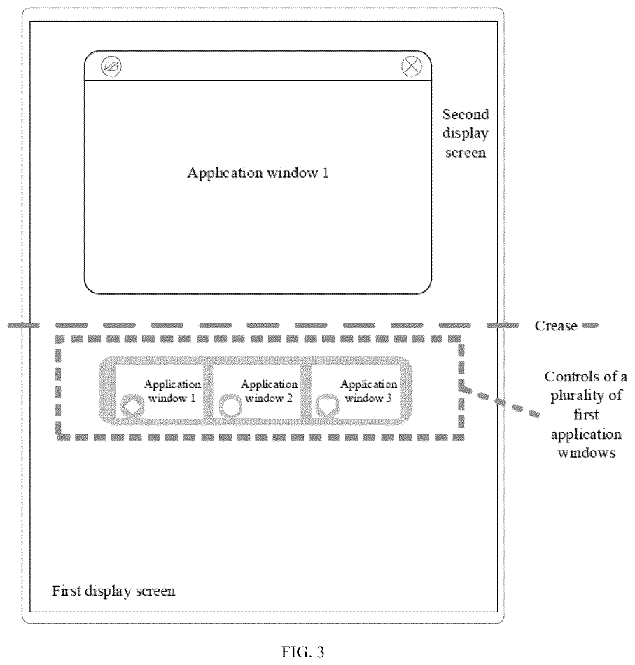

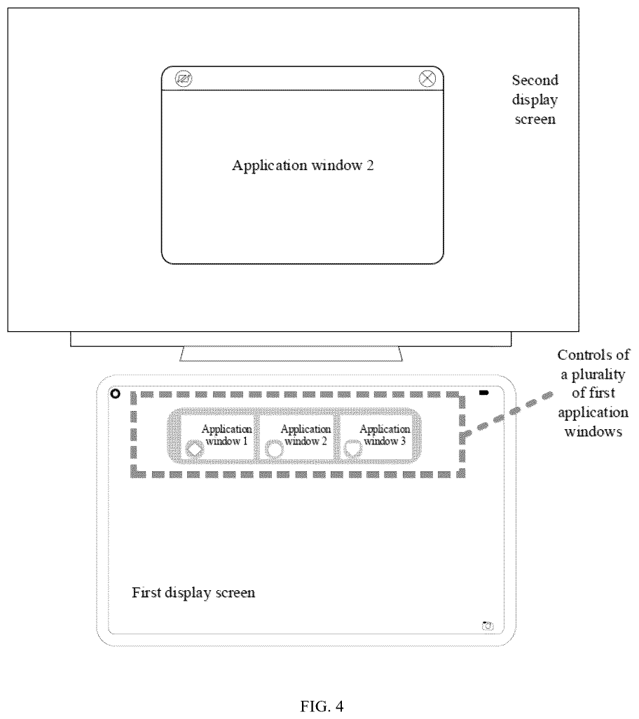

For more intuitive understanding of this solution, refer to FIG. 3 and FIG. 4. FIG. 3 is a diagram of displaying a control of a first application window at a top of a first display screen according to an embodiment of this application, and FIG. 4 is another diagram of displaying a control of a first application window at a top of a first display screen according to an embodiment of this application. First, refer to FIG. 3. An example in which a first display screen and a second display screen are integrated is used in FIG. 3. It should be noted that FIG. 3 is an example used to allow a user to more clearly see a position of a control of a first application window on the display screen, by displaying a folded electronic device in an unfolded state to the user. As shown in FIG. 3, a plurality of first application windows (to be specific, an application window 1, an application window 2, and an application window 3 in FIG. 3) in total are started on the electronic device, the application window 1 in the plurality of first application windows is in a displayed state, controls of the plurality of first application windows are located at a top of the first display screen, and the top of the first display screen is a region that is in the first display screen and that is close to the second display screen. It should be understood that the example in FIG. 3 is merely for ease of understanding of this solution, and is not intended to limit this solution.

Further refer to FIG. 4. In FIG. 4, an example in which a first display screen and a second display screen are respectively display screens of two electronic devices is used. A plurality of first application windows (to be specific, an application window 1, an application window 2, and an application window 3 in FIG. 4) in total are started on the first display screen and the second display screen. The application window 2 in the plurality of first application windows is in a displayed state, and controls of the plurality of first application windows are located at a top of the first display screen. It should be understood that the example in FIG. 4 is merely for ease of understanding of this solution, and is not intended to limit this solution.

It should be noted that in both FIG. 3 and FIG. 4, only an example in which “a control of at least one first application window is located in a central region at the top of the first display screen” is used for description. The control of the at least one first application window may alternatively be located in a left region at the top of the first display screen, or the control of the at least one first application window may be located in a right region at the top of the first display screen, or a position of the control of the at least one first application window at the top of the first display screen is adjustable. Specifically, this may be flexibly determined with reference to an actual situation. This is not limited in embodiments of this application.

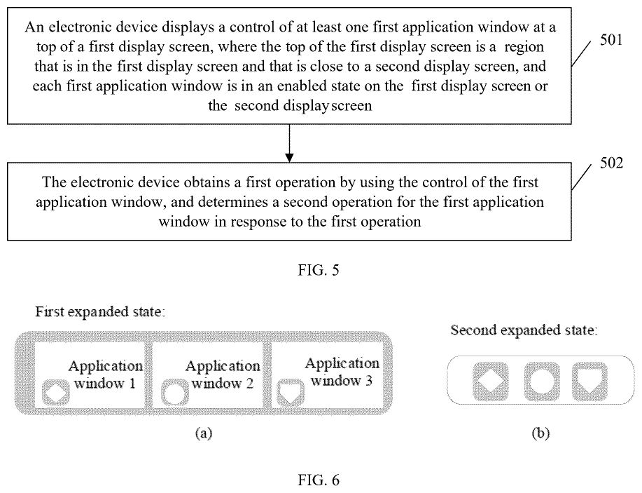

With reference to the foregoing description, the following starts to describe a specific implementation procedure of the application window processing method provided in embodiments of this application. FIG. 5 is a schematic flowchart of an application window processing method according to an embodiment of this application. The image processing method provided in this embodiment of this application may include the following steps:

501: An electronic device displays a control of at least one first application window at a top of a first display screen, where the top of the first display screen is a region that is in the first display screen and that is close to a second display screen, and each first application window is in an enabled state on the first display screen or the second display screen.

In this embodiment of this application, the electronic device may include the first display screen and the second display screen. For example, as shown in FIG. 1 and sub-diagram (a) of FIG. 2, when the first display screen and the second display screen belong to a same electronic device, the electronic device in this application may include both the first display screen and the second display screen. Alternatively, the electronic device may include only the first display screen. For example, as shown in sub-diagram (b) of FIG. 2, when the first display screen and the second display screen belong to different electronic devices, the electronic device in this application may include only the first display screen. A specific product form may be determined with reference to an actual application scenario. This is not limited in embodiments of this application.

Each first application window refers to an application window in an enabled state on the first display screen or the second display screen. For example, if an application window in an enabled state exists only on the second display screen, the “at least one first application window” may include all application windows in an enabled state on the second display screen; if an application window in an enabled state exists only on the first display screen, the “at least one first application window” may include all application windows in an enabled state on the first display screen; or if an application window in an enabled state exists both on the first display screen and the second display screen, the “at least one first application window” may include all application windows in an enabled state on the first display screen and all application windows in an enabled state on the second display screen.

The first application window being in an enabled state on the first display screen or the second display screen includes the following: The first application window is displayed on the first display screen, the first application window is displayed on the second display screen, the first application window is in a collapsed state on the first display screen, or the first application window is in a collapsed state on the second display screen.

The top of the first display screen is a region that is in the first display screen and that is close to the second display screen, and the second display screen is located above the first display screen. For a meaning of “displaying a control of at least one first application window at a top of a first display screen”, refer to the foregoing description for understanding. Details are not described herein again.

For example, when the control of the at least one first application window is in a first displayed state, the control of each first application window includes a thumbnail of the first application window and/or a first icon of an application program corresponding to the first application window. “The application program corresponding to the first application window” may also be understood as “the first application window is started in the application program”, or may be understood as “the first application program comes from the application program”, or the like.

To elaborate, the control of each first application window may include the thumbnail of the first application window and the first icon of the application program corresponding to the first application window, or may include only the thumbnail of the first application window, or may include only the first icon.

That the control of the first application window is in the first displayed state may also be understood as that the first application window is in an expanded state. Optionally, the first displayed state may include a first expanded state and a second expanded state, and “an area occupied by the control of the at least one first application window in the first expanded state” is greater than “an area occupied by the control of the at least one first application window in the second expanded state”. For example, when the control of each first application window is in the first expanded state, the control of each first application window may include a first thumbnail of the first application window and the first icon of the application program corresponding to the first application window. When the control of each first application window is in the second expanded state, the control of each first application window may include only the first icon of the application program corresponding to the first application window.

For more intuitive understanding of this solution, refer to FIG. 6. FIG. 6 is two diagrams of a control of at least one first application window according to an embodiment of this application. FIG. 6 includes two sub-diagrams (a) and (b). Sub-diagram (a) in FIG. 6 represents a diagram of the control of the first application window in the first expanded state, and sub-diagram (b) in FIG. 6 represents a diagram of the control of the first application window in the second expanded state. As shown in sub-diagram (a) of FIG. 6, when the control of the first application window is in the first expanded state, the control of each first application window includes the thumbnail of the first application window and an icon of an application program corresponding to the first application window.

As shown in sub-diagram (b) of FIG. 6, when the control of the first application window is in the second expanded state, the control of each first application window includes only an icon of an application program corresponding to the first application window. It should be understood that the example in FIG. 6 is merely for ease of understanding of this solution, and is not intended to limit this solution.

For another example, when the control of each first application window is in the first expanded state, the control of each first application window may include the first thumbnail of the first application window and the first icon of the application program corresponding to the first application window. When the control of each first application window is in the second expanded state, the control of each first application window may include only a second thumbnail of the first application window. Both the first thumbnail of the first application window and the second thumbnail of the first application window are thumbnails of the first application window. A difference lies in that an area of the first thumbnail is greater than an area of the second thumbnail and the like. The first expanded state and the second expanded state may alternatively be presented as display manners. This is not limited in embodiments of this application.

In this embodiment of this application, the control of each first application window uses the thumbnail of the first application window and/or the icon of the application program corresponding to the first application window. Therefore, the user may intuitively learn, based on the displayed control of each first application window, that each control is used to obtain a control operation of which application window, thereby further improving convenience of the user in a process of controlling the application window.

Specifically, in an application scenario, the first display screen and the second display screen belong to a same electronic device, and “at least one first application window” may alternatively be understood as at least one first application window that is in an enabled state in the electronic device including the first display screen and the second display screen. The electronic device can obtain a thumbnail of each first application window and an icon of an application program corresponding to each first application window. Therefore, the electronic device can determine the control of each first application window.

In another application scenario, the first display screen and the second display screen belong to different electronic devices, and an electronic device including only the first display screen (for ease of description, referred to as a “first electronic device” subsequently) may learn which first application windows are in an enabled state on the first display screen. Similarly, the first electronic device can determine a control of each first application window in an enabled state on the first display screen.

Optionally, if at least one first application window in an enabled state exists on the second display screen, an electronic device including only the second display screen (for ease of description, referred to as a “second electronic device” subsequently) may send first information to the first electronic device. The first electronic device determines, based on the first information, a control corresponding to each first application window in an enabled state on the second display screen. For example, the first information may include a thumbnail of each first application window in an enabled state on the second display screen and/or an icon of an application program corresponding to each first application window.

Specifically, in an implementation, when a control of at least one first application window needs to be displayed, the first displayed state is always used. To be specific, there is no another displayed state of the control of the at least one first application window.

In another implementation, the control of the at least one first application window further has a second displayed state, and that the control of the at least one first application window is in the second displayed state may alternatively be understood as that the first application window is in a collapsed state. When the control of the at least one first application window is in the second displayed state, a second icon corresponding to the control of the at least one first application window is displayed on the first display screen, the second icon is used to obtain a third operation, and the third operation is used to switch the control of the at least one first application window from the second displayed state to the first displayed state.

For example, the second icon may be an icon of an application program corresponding to an application window in the at least one first application window. Optionally, “an application window” may be an application window that is being processed by the electronic device in the at least one first application window, and the second icon may be used to remind the user of an application window being processed by the electronic device currently, so that the user can learn more information.

Alternatively, the second icon may be different from an icon of an application program corresponding to any application window in the at least one first application window, and the second icon may be an independently designed icon or the like. Details may be flexibly determined with reference to an actual situation, and is not limited herein.

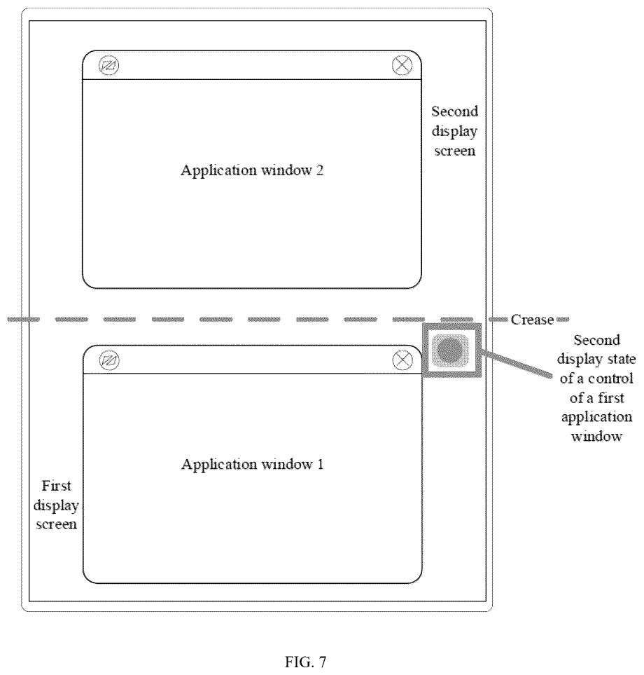

For more intuitive understanding of this solution, refer to FIG. 7. FIG. 7 is another diagram of a control of at least one first application window according to an embodiment of this application. As shown in FIG. 7, when the control of the at least one first application window uses the second displayed state, the control of the at least one first application window is represented as a second icon. In FIG. 7, an example in which the second icon is an icon of an application program corresponding to an application window 2 is used. The application window 2 is an application window being processed by the electronic device. It should be understood that the example in FIG. 7 is merely for ease of understanding of this solution, and is not intended to limit this solution.

In this embodiment of this application, when the control of the at least one first application window is in the second displayed state, controls of all first application windows are presented as one second icon, and areas occupied by the controls of all the first application windows are smaller. Therefore, when the control of the first application window does not need to be used, the control of the first application window can be collapsed, so as to prevent the control of the first application window from blocking a line of sight of the user, so as to fully utilize the screen of the first display screen. In addition, the second icon is used to obtain a third operation, and the control of the first application window may be switched from the second displayed state back to the first displayed state by using the third operation. Therefore, when the control of the first application window needs to be used, the control of the first application window can be conveniently expanded.

It should be noted that a specific implementation of switching the control of the at least one first application window between “the first expanded state” and “the second expanded state” and a specific implementation of switching the control of the at least one first application window between “the first displayed state” and “the second displayed state” are described in subsequent descriptions, and details are not described herein.

Optionally, when the control of the at least one first application window is displayed on the first display screen, an input control may be further displayed. When the control of the at least one first application window and the input control are both displayed on the first display screen, the control of the at least one first application window is located on an upper side of the input control, and the input control includes a keyboard and/or a touchpad. In the foregoing layout manner, when the first application window is controlled by using the control of the first application window displayed on the first display screen, the keyboard and/or the touchpad may also be conveniently used. In addition, because the control of the first application window is located on the upper side of the input control, it is not easy to cause an accidental touch on the control of the first application window in a process of using the keyboard and/or the touchpad.

For example, a mode of displaying the input control on the first display screen includes any one or more of the following: displaying a thumbnail of the touchpad and the keyboard; displaying a thumbnail of the keyboard and the touchpad; displaying the thumbnail of the touchpad and the thumbnail of the keyboard; displaying both the keyboard and the touchpad, where the touchpad is located on an upper side or a lower side of the keyboard; displaying both the keyboard and the touchpad, where the touchpad is located on a left side or a right side of the keyboard; or another display manner of the keyboard and the touchpad. Details may be flexibly determined with reference to an actual application scenario. This is not limited in embodiments of this application. A plurality of display modes of the keyboard and the touchpad are provided, which helps adapt to various application scenarios and improves implementation flexibility of this solution.

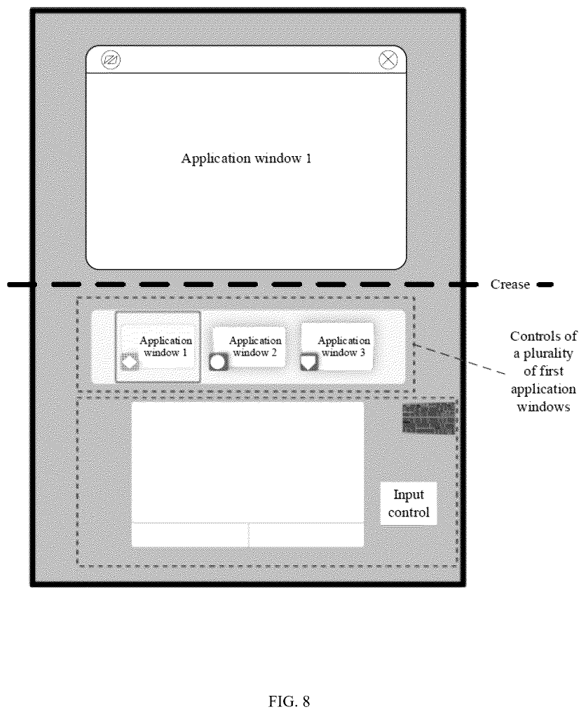

For more intuitive understanding of this solution, refer to FIG. 8. FIG. 8 is a diagram of displaying a control of a first application window and an input control on a first display screen according to an embodiment of this application. FIG. 8 is an example used to allow a user to more clearly see a position of a control of a first application window on the display screen, by displaying a folded electronic device in an unfolded state. As shown in FIG. 8, the first display screen is below a crease, the second display screen is above the crease, and the input control include a keyboard and a touchpad. In FIG. 8, for example, the thumbnail of the keyboard and the touchpad are displayed. The control of the first application window and the input control are both located on the first display screen. In addition, the control of the first application window is located on the upper side of the input control. It should be understood that the example in FIG. 8 is merely for ease of understanding of this solution, and is not intended to limit this solution.

For example, this embodiment of this application further provides an implementation of switching the input control between a plurality of display modes. Optionally, in a process of switching the input control between a plurality of display modes, automatic adjustment of an area occupied by the control of the at least one first application window can be triggered. For example, a factor that triggers adjustment of the area occupied by the control of the at least one first application window includes: the input control is switched between a first display mode and a second display mode. The first display mode is displaying both the keyboard and the touchpad, with the touchpad on the upper side or the lower side of the keyboard. The second display mode is any one of the following plurality of display modes: displaying the thumbnail of the touchpad and the keyboard, displaying the thumbnail of the keyboard and the touchpad, or displaying both the keyboard and the touchpad, with the touchpad on the left side or the right side of the keyboard.

In this embodiment of this application, because a width of the second display screen is fixed, when both the keyboard and the touchpad are displayed, and the touchpad is displayed on the upper side or the lower side of the keyboard, widths of the touchpad and the keyboard are compressed. In this case, the area occupied by the control of the at least one first application window is automatically reduced, so that the touchpad and the keyboard are wider, and user experience of using the touchpad and the keyboard is improved. When the touchpad and the keyboard are no longer displayed in upper and lower positions, the widths of the touchpad and the keyboard are no longer compressed. In this case, the area occupied by the control of the at least one first application window is automatically enlarged, which helps enhance user experience of the control of the first application window. That is, by using the foregoing solution, the area occupied by the control of the first application window can be automatically adjusted with reference to an actual scenario, which helps enhance user experience.

Optionally, when the display mode of the input control is the second display mode, the control of the at least one first application window may use the first expanded state. When the display mode of the input control is the first display mode, the control of the at least one first application window may use the second expanded state. For meanings of “the first expanded state” and “the second expanded state”, refer to the foregoing descriptions. Details are not described herein again.

In an application scenario, switching the input control displayed on the first display screen between different display modes may include switching between “displaying the thumbnail of the keyboard and the touchpad” and “displaying the thumbnail of the touchpad and the keyboard”.

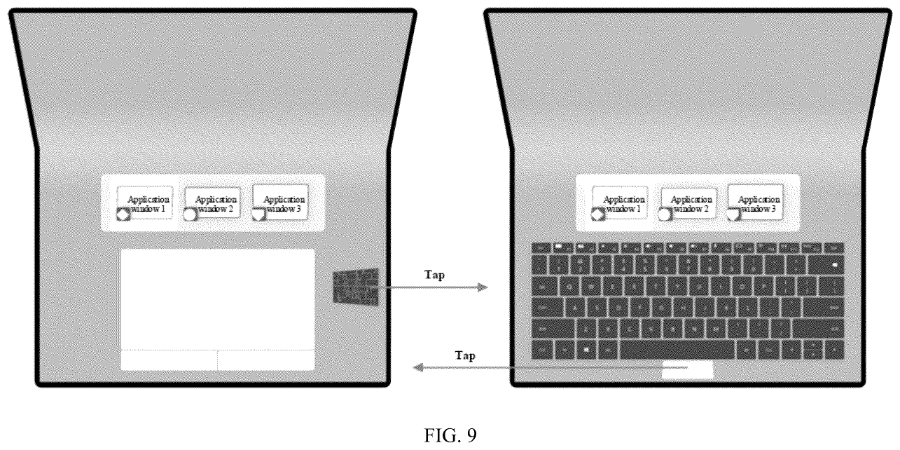

For example, refer to FIG. 9. FIG. 9 is a diagram of switching between “displaying a thumbnail of a keyboard and a touchpad” and “displaying a thumbnail of the touchpad and the keyboard” according to an embodiment of this application. FIG. 9 includes two sub-diagrams: a left sub-diagram and a right sub-diagram. In the left sub-diagram and the right sub-diagram of FIG. 9, an example in which the electronic device is a foldable screen device is used. Controls of a plurality of first application windows (for example, an application window 1, an application window 2, and an application window 3 in FIG. 9) and an input control are all displayed on the first display screen. The thumbnail of the keyboard and the touchpad are displayed in the left sub-diagram of FIG. 9, and the thumbnail of the touchpad and the keyboard are displayed in the right sub-diagram of FIG. 9.

In the left sub-diagram of FIG. 9, when the user taps the thumbnail of the keyboard (correspondingly, the electronic device obtains a tap operation for the thumbnail of the keyboard), entering the right sub-diagram of FIG. 9 may be triggered. That is, displaying of the keyboard is triggered. In addition, the touchpad is collapsed, and the thumbnail of the touchpad is displayed on the first display screen.

Correspondingly, the user may tap the thumbnail of the touchpad (correspondingly, the electronic device obtains a tap operation for the thumbnail of the touchpad) to trigger displaying of the touchpad. In addition, the keyboard is collapsed, and the thumbnail of the keyboard is displayed on the first display screen. That is, the right sub-diagram of FIG. 9 is switched to the left sub-diagram of FIG. 9. It should be noted that, in FIG. 9, only an example in which the thumbnail of the keyboard is displayed on a right side of the touchpad, and the thumbnail of the touchpad is displayed on a lower side of the keyboard is used in this embodiment, and “the thumbnail of the keyboard” and “the thumbnail of the touchpad” may alternatively be placed at other positions. The example in FIG. 9 is merely for ease of understanding of this solution, and is not intended to limit this solution.

It should be noted that the example herein is merely used to prove that switching between “displaying the thumbnail of the keyboard and the touchpad” and “displaying the thumbnail of the touchpad and the keyboard” is implementable, and is not used to limit this solution.

In another application scenario, switching the input control displayed on the first display screen between different display modes may include switching from “displaying the thumbnail of the keyboard and the touchpad” to “displaying both the keyboard and the touchpad, with the touchpad on the upper side or the lower side of the keyboard”. For example, the user may drag the thumbnail of the keyboard to a first preset region to trigger displaying of both the keyboard and the touchpad, with the touchpad on the lower side of the keyboard, and the first preset region may be located between space of the first application window and the touchpad. The user may drag the thumbnail of the keyboard to a second preset region to trigger displaying of both the keyboard and the touchpad, with the touchpad on the upper side of the keyboard, and the second preset region may be located on the lower side of the touchpad.

In another application scenario, switching the input control displayed on the first display screen between different display modes may include switching from “displaying the thumbnail of the touchpad and the keyboard” to “displaying both the keyboard and the touchpad, with the touchpad on the upper side or the lower side of the keyboard”. For example, the user may drag the thumbnail of the touchpad to the first preset region, to trigger displaying of both the keyboard and the touchpad, with the touchpad on the upper side of the keyboard. The user may drag the thumbnail of the touchpad to the second preset region, to trigger displaying of both the keyboard and the touchpad, with the touchpad on the lower side of the keyboard.

Optionally, when the display mode of the input control is switched from the second display mode to “displaying both the keyboard and the touchpad on the first display screen, with the touchpad on the upper side or the lower side of the keyboard (namely, the first display mode)”, the area occupied by the control of the at least one first application window may automatically decrease.

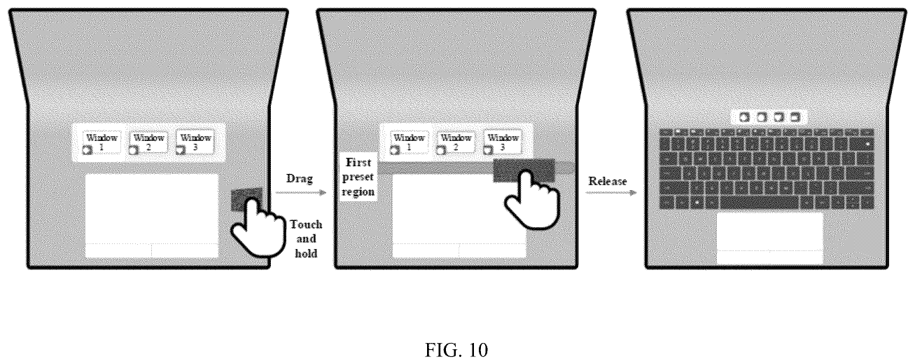

For more intuitive understanding of this solution, refer FIG. 10. FIG. 10 is a diagram of switching from “displaying a thumbnail of a keyboard and a touchpad” to “displaying both the keyboard and the touchpad, with the touchpad on an upper side of the keyboard” according to an embodiment of this application. It should be noted that, because an area for displaying a control of each first application window is relatively small, to clearly see each accompanying drawing as far as possible, in FIG. 10 and a plurality of subsequent accompanying drawings, “application window” in the control of the first application window is replaced with “window”. In other words, in FIG. 10 and a plurality of subsequent accompanying drawings, meanings of “window” and “application window” are consistent. FIG. 10 includes three sub-diagrams: a left sub-diagram, a middle sub-diagram, and a right sub-diagram. As shown in the left sub-diagram of FIG. 10, controls of a plurality of first application windows and an input control are displayed on the first display screen of the electronic device, and a display mode of the input control is displaying a thumbnail of a keyboard and a touchpad. In the left sub-diagram and the middle sub-diagram of FIG. 10, the user touches and holds the thumbnail of the keyboard and drags the thumbnail of the keyboard to the first preset region, so as to trigger entering the right sub-diagram of FIG. 10, that is, trigger displaying of both the keyboard and the touchpad, with the touchpad on the lower side of the keyboard. In addition, when both the keyboard and the touchpad are displayed on the first display screen, with the touchpad on the lower side of the keyboard, an area occupied by a control of at least one first application window is also triggered to automatically decrease. It should be understood that the example in FIG. 10 is merely for ease of understanding of this solution, and is not intended to limit this solution.

In another application scenario, switching the input control displayed on the first display screen between different display modes may include switching from “displaying the thumbnail of the keyboard and the touchpad” to “displaying both the keyboard and the touchpad, with the touchpad on the left side or the right side of the keyboard”. For example, the user may drag the thumbnail of the keyboard to a left region of a region occupied by the touchpad, to trigger displaying of both the keyboard and the touchpad, with the touchpad on the right side of the keyboard. The user may drag the thumbnail of the keyboard to a right region of the region occupied by the touchpad, to trigger displaying of both the keyboard and the touchpad, with the touchpad on the left side of the keyboard.

In another application scenario, switching the input control displayed on the first display screen between different display modes may include switching from “displaying the thumbnail of the touchpad and the keyboard” to “displaying both the keyboard and the touchpad, with the touchpad on the left side or the right side of the keyboard”. For example, the user may drag the thumbnail of the touchpad to a left region of a region occupied by the keyboard, to trigger displaying of both the keyboard and the touchpad, with the touchpad on the left side of the keyboard. The user may drag the thumbnail of the touchpad to a right region of the region occupied by the keyboard, to trigger displaying of both the keyboard and the touchpad, with the touchpad on the right side of the keyboard.

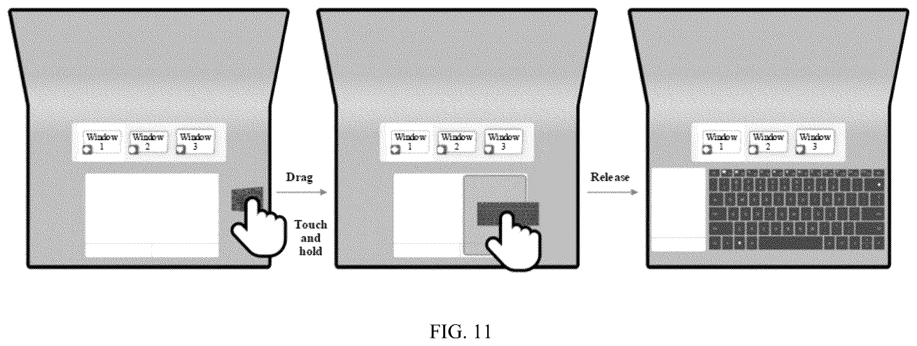

For more intuitive understanding of this solution, refer FIG. 11. FIG. 11 is a diagram of switching from “displaying a thumbnail of a keyboard and a touchpad” to “displaying both the keyboard and the touchpad, with the touchpad on a left side of the keyboard” according to an embodiment of this application. FIG. 11 includes three sub-diagrams: a left sub-diagram, a middle sub-diagram, and a right sub-diagram. For the left sub-diagram of FIG. 11, refer to the left sub-diagram of FIG. 10 for understanding. Details are not described herein again. In the left sub-diagram and the middle sub-diagram of FIG. 11, the user touches and holds the thumbnail of the keyboard and drags the thumbnail of the keyboard to the right region in the region occupied by the touchpad, to trigger entering the right sub-diagram of FIG. 11, that is, trigger displaying of both the keyboard and the touchpad, with the touchpad on the left side of the keyboard. It should be understood that the example in FIG. 11 is merely for ease of understanding of this solution, and is not intended to limit this solution.

In another application scenario, switching the input control displayed on the first display screen between different display modes may include: displaying both the keyboard and the touchpad in contact, for example, switching from “displaying both the keyboard and the touchpad, with the touchpad on the upper side or the lower side of the keyboard” to “displaying the thumbnail of the touchpad and the keyboard”, or to “displaying the thumbnail of the keyboard and the thumbnail of the keyboard”; and for another example, switching from “displaying both the keyboard and the touchpad, with the touchpad on the left side or the right side of the keyboard” to “displaying the thumbnail of the touchpad and the keyboard”, or to “displaying the thumbnail of the keyboard and the thumbnail of the keyboard”.

Optionally, when the display mode of the input control is switched from “displaying both the keyboard and the touchpad on the first display screen, with the touchpad on the upper side or the lower side of the keyboard (namely, the first display mode)” to the second display mode, the area occupied by the control of the at least one first application window may automatically increase. For a meaning of “the second display mode”, refer to the foregoing description. Details are not described herein again.

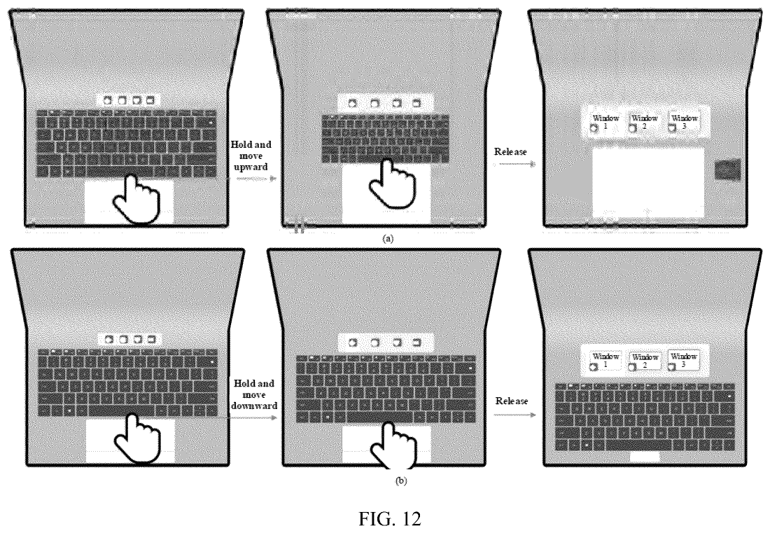

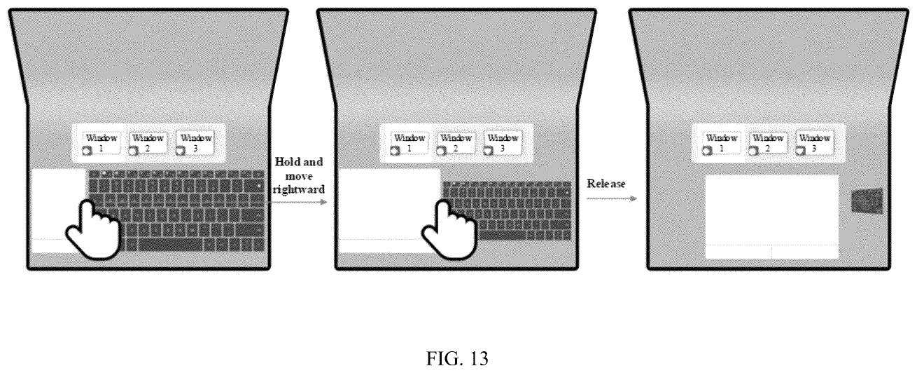

For example, refer to FIG. 12 and FIG. 13. FIG. 12 and FIG. 13 are a plurality of diagrams of switching an input control between different display modes according to an embodiment of this application. First, refer to FIG. 12. FIG. 12 includes two sub-diagrams (a) and (b). In FIG. 12, when both a keyboard and a touchpad are displayed, a boundary between the keyboard and the touchpad is adjustable. As shown in sub-diagram (a) of FIG. 12, when the user taps the boundary between the keyboard and the touchpad and pushes the boundary upward, an area occupied by the touchpad and an area occupied by a control of a first application window gradually increase, and an area occupied by the keyboard gradually decreases. When an upward pushing distance exceeds a first preset threshold, after the user releases the tap operation on the boundary between the keyboard and the touchpad, the keyboard changes to be displayed on the first display screen in a thumbnail manner.

As shown in sub-diagram (b) of FIG. 12, when the user taps the boundary between the keyboard and the touchpad and pushes the boundary downward, the area occupied by the keyboard and the area occupied by the control of the first application window gradually increase, and the area occupied by the touchpad gradually decreases. When a downward pushing distance exceeds the first preset threshold, after the user releases the tap operation on the boundary between the keyboard and the touchpad, the touchpad changes to be displayed on the first display screen in a thumbnail manner. It should be understood that the example in FIG. 12 is merely for ease of understanding of this solution, and is not intended to limit this solution.

Further refer to FIG. 13. In FIG. 13, when both the keyboard and the touchpad are displayed, the boundary between the keyboard and the touchpad is adjustable. When the user taps the boundary between the keyboard and the touchpad and pushes the boundary rightward, the area occupied by the touchpad gradually increases, and the area occupied by the keyboard gradually decreases. When a rightward pushing distance exceeds a second preset threshold, after the user releases the tap operation on the boundary between the keyboard and the touchpad, the keyboard changes to be displayed on the first display screen in a thumbnail manner. It should be understood that the example in FIG. 13 is merely for ease of understanding of this solution, and is not intended to limit this solution. Similarly, when a tap operation is performed on the boundary between the keyboard and the touchpad and a distance by which the boundary is pushed leftward exceeds the second preset threshold, after the tap operation is released, the touchpad is triggered to be displayed on the first display screen in a thumbnail manner.

It should be noted that the foregoing examples of manners of switching the input control between the plurality of display modes are merely used to prove implementability of this solution. A specific switching manner may be flexibly determined with reference to an actual product form. This is not limited in embodiments of this application.

Optionally, this embodiment of this application further provides how to manually adjust an area occupied by a control of at least one first application window while keeping the input control displayed in the first display mode when the input control uses the first display mode (to be specific, both the keyboard and the touchpad are displayed on the first display screen, with the touchpad on the upper side or the lower side of the keyboard).

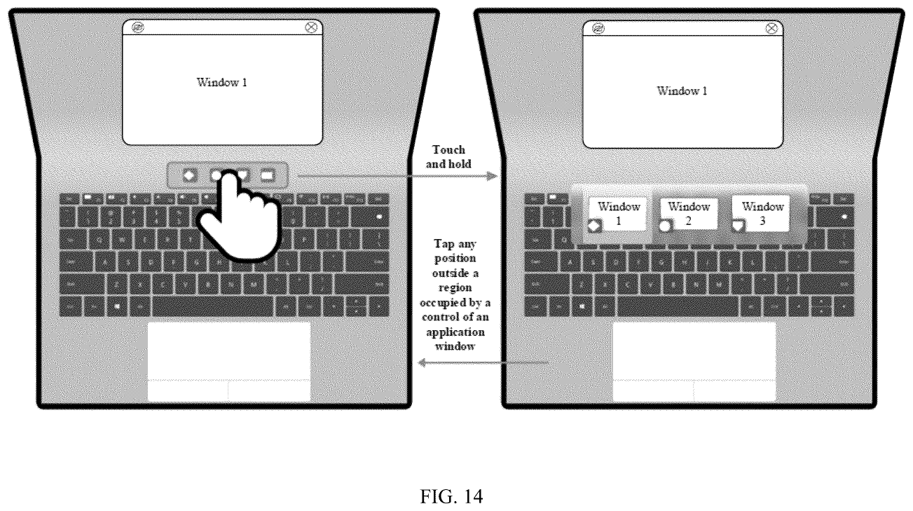

For example, refer to FIG. 14. FIG. 14 is a diagram of adjusting an area occupied by a control of a first application window according to an embodiment of this application. When the electronic device obtains that a touch-and-hold operation input for a region in which a control of at least one first application window is located reaches first duration, an area occupied by the control of the at least one first application window may be triggered to increase (for example, the control of the at least one first application window is switched from the second expanded state to the first expanded state), and the area occupied by the keyboard and the area occupied by the touchpad are not affected. In other words, switching from a left sub-diagram of FIG. 14 to a right sub-diagram of FIG. 14. After the user completes the control operation on the first application window by using the control of the at least one first application window, if the user wants to reduce the area occupied by the control of the first application window, the user may tap any position outside a region in which the control of the at least one first application window is located, to trigger a decrease of the area occupied by the control of the at least one first application window (for example, the control of the at least one first application window is switched from the first expanded state to the second expanded state). In other words, switching from the right sub-diagram of FIG. 14 to the left sub-diagram of FIG. 14 is implemented.

It should be noted that the example in FIG. 14 is merely for ease of understanding of this solution. For example, the touch-and-hold operation may alternatively be replaced with “a dual-finger spread gesture”, or the touch-and-hold operation may be replaced with “inputting a tap operation in a blank region in a region of the control of the at least one first application window”. This may be specifically and flexibly set with reference to an actual product form. This is not limited in embodiments of this application.

Optionally, if the electronic device is a foldable screen device, the control of the first application window and the input control may be automatically enabled or disabled according to a form of the electronic device. For example, when the electronic device enters a folded state from an unfolded state, the control of the first application window and the input control may be triggered to be automatically enabled. When the electronic device enters the unfolded state from the folded state, the control of the first application window and the input control may be triggered to be automatically disabled.

502: The electronic device obtains a first operation by using the control of the first application window, and determines a second operation for the first application window in response to the first operation.

In this embodiment of this application, the second operation for the first application window may be used to start the first application window, collapse the first application window, adjust a position or a size of the first application window, perform another function, or the like. This is not limited in embodiments of this application.

For example, a second operation for any first application window in the at least one first application window may be any one of the following operations: switching the first application window from being collapsed to being displayed; switching the first application window from being displayed on the first display screen to being displayed on the second display screen; switching the first application window from being displayed on the second display screen to being displayed on the first display screen; adjusting a display position of the first application window on a same display screen; adjusting a size of the first application window; another operation for the first application window; or the like. Examples are not exhaustive in embodiments of this application. A plurality of control operations on the first application window can be implemented by using the control of the first application window, and the user can conveniently perform a plurality of operations on the first application window by using the control of the first application window, thereby improving user viscosity of this solution.

The following describes in detail an implementation in which the user implements a plurality of control operations on the first application window by using the control of the first application window. In an application scenario, when the first operation is a tap operation obtained by using the control of the first application window, that is, when the user taps the control of the first application window, the second operation is switching the first application window from being collapsed to being displayed. It should be noted that “the tap operation obtained by using the control of the first application window” may alternatively be replaced with another operation. The example herein is merely for ease of understanding of this solution, and is not intended to limit this solution.

Optionally, in an implementation, that a target application window (that is, any one of the at least one first application window) is in a displayed state may be further classified into pin on top and unpin on top. Specifically, a plurality of application windows may be simultaneously displayed on one display screen of the electronic device, and the plurality of application windows may be displayed in a stacked manner. An application window that is being processed by the electronic device is displayed on top. When the first operation is a tap operation obtained by using a control of the target application window, the second operation may be enabling the target application window to switch from unpin on top to pin on top, or switch from pin on top to collapsed, or switch from collapsed to pin on top.

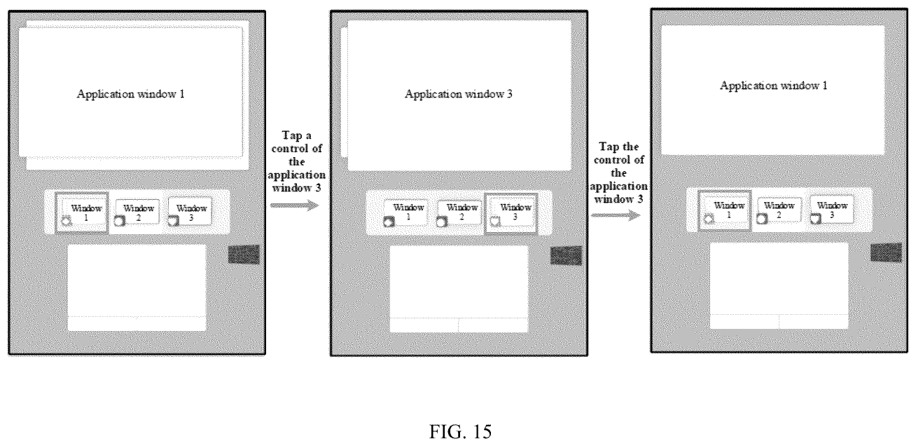

For more intuitive understanding of this solution, refer to FIG. 15. FIG. 15 is a diagram of switching a target application window between displayed and collapsed by using a control of the target application window according to an embodiment of this application. In FIG. 15, an example in which a target application window is an application window 2 is used. FIG. 15 includes three sub-diagrams: a left sub-diagram, a middle sub-diagram, and a right sub-diagram. As shown in the left sub-diagram of FIG. 15, an application window 1, the application window 2, and an application window 3 are all in an enabled state, and the application window 1 is displayed at the topmost layer of the second display screen (that is, pinned on top). A control of the application window 1 is in a highlighted state, indicating that an application window being processed by the electronic device is the application window 1, and the application window 3 is in an unpin on top state. After the user inputs a tap operation on a control of the application window 3, entering the middle sub-diagram of FIG. 15 is triggered, and the application window 3 is switched from unpin on top to pin on top. To be specific, the application window 3 is displayed at the topmost layer of the second display screen. The control of the application window 3 is in a highlighted state, indicating that an application window being processed by the electronic device is the application window 3.

After the user inputs a tap operation on the control of the application window 3 again, entering the right sub-diagram of FIG. 15 is triggered, the application window 3 is switched from pin on top to collapsed, and the control of the application window 3 is no longer in a highlighted state. After the application window 3 is collapsed, the application window 1 is at the topmost layer of the second display screen. Therefore, the control of the application window 1 is in a highlighted state. It should be understood that the example in FIG. 15 is merely for ease of understanding of this solution, and is not intended to limit this solution.

In another implementation, only one application window can be displayed on a same display screen of the electronic device at the same time. For example, an application window A and an application window B are in an enabled state on the second display screen of the electronic device. When the application window A is displayed on the second display screen, the application window B automatically collapses. When the application window B is displayed on the second display screen, the application window A automatically collapses. In this case, the target application window (that is, any one of the at least one first application window) has only one displayed state. When the first operation is a tap operation obtained by using a control of the target application window, the second operation may be switching the target application window from displayed to collapsed, or switching from collapsed to displayed.

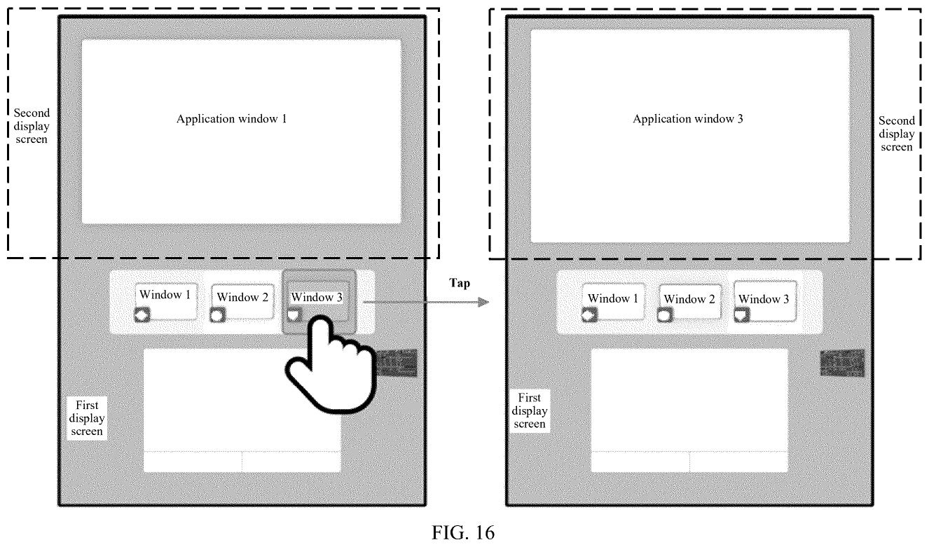

For more intuitive understanding of this solution, refer to FIG. 16. FIG. 16 is another diagram of switching a first application window between displayed and collapsed by using a control of the first application window according to an embodiment of this application. FIG. 16 includes two sub-diagrams: a left sub-diagram and a right sub-diagram. The electronic device has three enabled application windows in total: an application window 1, an application window 2, and an application window 3. In the left sub-diagram of FIG. 16, the application window 2 and the application window 3 are collapsed, and the application window 1 is displayed on the second display screen. Because the application window 3 is displayed on the second display screen before being collapsed, when the user taps a control of the application window 3, entering the right sub-diagram of FIG. 16 is triggered. To be specific, the application window 1 remains collapsed, the application window 2 switches from displayed to collapsed, the application window 3 switches from collapsed to displayed on the second display screen, and the control of the application window 3 is in a highlighted state. It should be understood that the example in FIG. 16 is merely for ease of understanding of this solution, and is not intended to limit this solution.

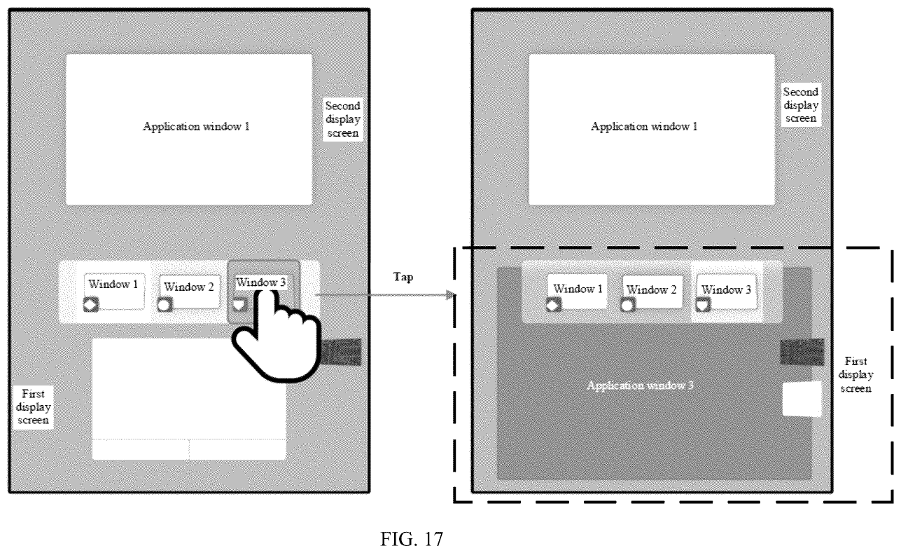

Optionally, if the electronic device includes the first display screen and the second display screen, one application window may be displayed on each of the first display screen and the second display screen of the electronic device. For more intuitive understanding of this solution, refer to FIG. 17. FIG. 17 is a diagram of switching a first application window from collapsed to displayed by using a control of the first application window according to an embodiment of this application. A left sub-diagram of FIG. 17 is similar to the left sub-diagram of FIG. 16. Refer to FIG. 16 for understanding. Details are not described herein again.

Because the application window 3 is displayed on the first display screen before being collapsed, when the user taps the control of the application window 3, entering a right sub-diagram of FIG. 17 is triggered. In the right sub-diagram of FIG. 17, the application window 1 remains collapsed, the application window 2 is still displayed on the second display screen, and the application window 3 is displayed on the first display screen. It should be understood that the example in FIG. 17 is merely for ease of understanding of this solution, and is not intended to limit this solution.

In another application scenario, the second operation is switching the first application window from being displayed on the first display screen to being displayed on the second display screen, or switching the first application window from being displayed on the second display screen to being displayed on the first display screen. Optionally, when the first application window is displayed on the second display screen, and the first operation is a downward slide operation obtained by using the control of the first application window, the second operation is switching the first application window from being displayed on the second display screen to being displayed on the first display screen; or when the first application window is displayed on the first display screen, and the first operation is an upward slide operation obtained by using the control of the first application window, the second operation is switching the first application window from being displayed on the first display screen to being displayed on the second display screen. In the foregoing manner, the user may implement switching of the first application window between different display screens by inputting an upward slide operation or a downward slide operation on the control of the first application window. The upward slide operation or the downward slide operation is simple, and the foregoing implementation is very efficient.

Optionally, when the at least one first application window is displayed on the first display screen, a thumbnail of an input control is displayed on the first display screen, where the input control includes a keyboard and/or a touchpad. That is, when the at least one first application window is displayed on the first display screen, each input control is automatically triggered to be displayed in a thumbnail form. For example, when at least one first application window exists on the first display screen, displaying of a thumbnail of the keyboard and a thumbnail of the touchpad may be triggered.

Optionally, when the user wants to use the keyboard or the touchpad, the user may tap the thumbnail of the keyboard or the thumbnail of the touchpad. Correspondingly, the electronic device can obtain a tap operation on the thumbnail of the keyboard or the thumbnail of the touchpad, to trigger starting of the keyboard or the touchpad, and collapse the first application window displayed on the first display screen.

In the foregoing manner, when the user views the application window on the first display screen, the input control on the first display screen does not block the line of sight of the user, and the user can conveniently start the input control by using the thumbnail of the input control. This improves flexibility of this solution, and helps enhance user viscosity of this solution.

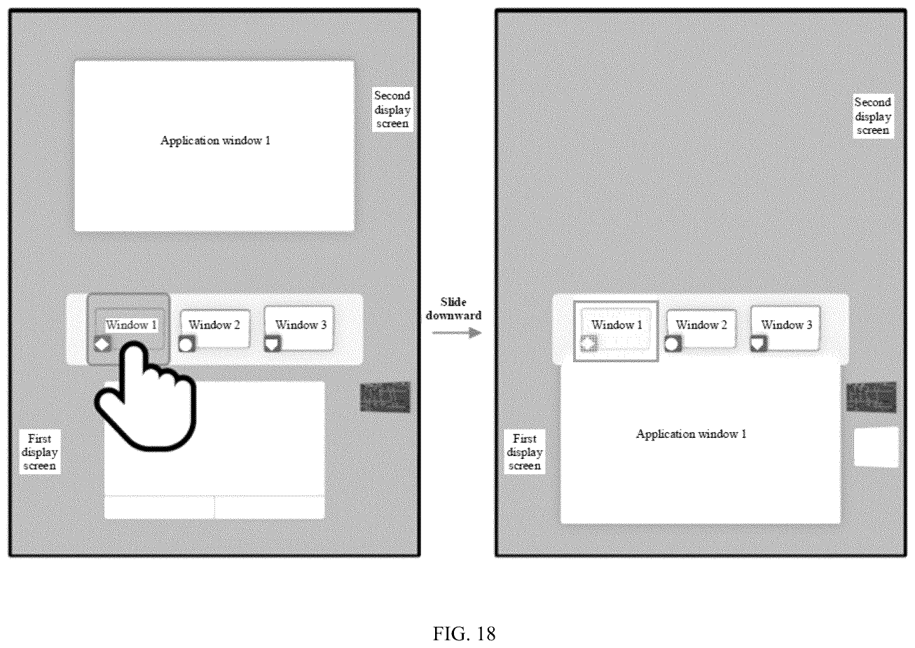

For more intuitive understanding of this solution, refer to FIG. 18. FIG. 18 is a diagram of switching a first application window from being displayed on a second display screen to being displayed on a first display screen according to an embodiment of this application. FIG. 18 includes two sub-diagrams: a left sub-diagram and a right sub-diagram. In the left sub-diagram of FIG. 18, the application window 1 is being displayed on the second display screen. When the user inputs a downward slide operation by using the control of the application window 1, entering the right sub-diagram of FIG. 18 may be triggered. To be specific, the application window 1 is triggered to switch from being displayed on the second display screen to being displayed on the first display screen, and each input control on the first display screen is displayed in a thumbnail form. To be specific, the display mode of the input control is automatically switched to: displaying the thumbnail of the keyboard and the thumbnail of the touchpad to avoid blocking the application window 1. It should be understood that the example in FIG. 18 is merely for ease of understanding of this solution, and is not intended to limit this solution.

When a first application window is switched from being displayed on the second display screen to being displayed on the first display screen, in an implementation, the electronic device may trigger a control of at least one first application window to be displayed on the first display screen in the second displayed state, that is, trigger the control of the at least one first application window to automatically collapse.

In another implementation, the control of the at least one first application window may remain unchanged. After the electronic device obtains a fourth operation input by the user, the control of the at least one first application window is triggered to be displayed on the first display screen in the second displayed state. For example, the fourth operation may be that the user inputs a tap operation on a region, in all regions included in the first display screen, different from a region occupied by the control of the at least one first application window, or the fourth operation may be a “circle gesture” input by the user, or the fourth operation may be a double-tap operation input by the user, or the like. This is not limited herein. By using the foregoing operation, it can be ensured that a previous operation of the user is not an accidental touch. In addition, if the previous operation is an accidental touch, the user may also perform adjustment in time by using the control of the at least one first application window.

Referring to the foregoing description, it can be learned that, when the control of the at least one first application window is in the second displayed state, a second icon corresponding to the control of the at least one first application window is displayed on the first display screen, and the second icon is used to obtain a third operation of switching the control of the at least one first application window from the second displayed state to the first displayed state.

For example, the third operation may be a tap operation input for the second icon, or the third operation may be dragging the second icon to a third preset region, or the third operation may be another operation input for the second icon, or the like. This is not limited in embodiments of this application.

Optionally, when the control of the at least one first application window is displayed on the first display screen in the second displayed state, closing of the input control on the first display screen may be triggered. When the control of the at least one first application window is displayed on the first display screen in the first displayed state, starting of the input control on the first display screen may be triggered. Therefore, blocking caused by the input control to the application window on the first display screen can be further reduced.

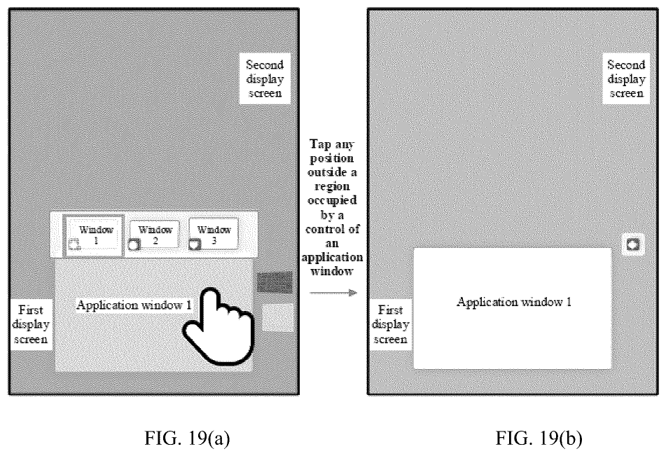

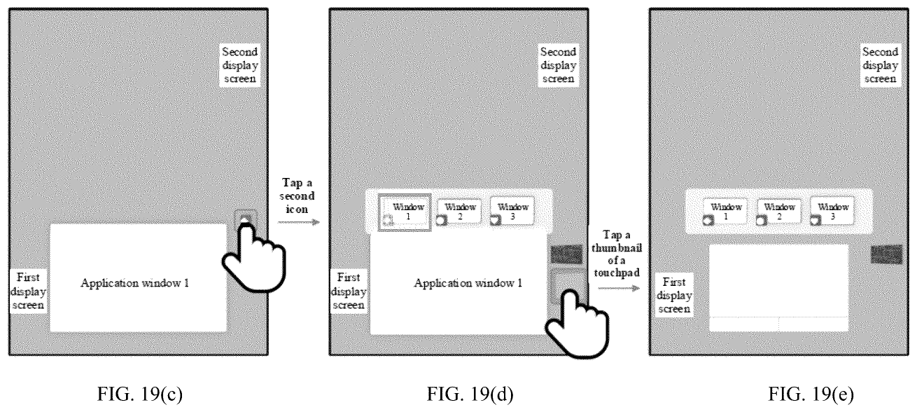

For more intuitive understanding of this solution, refer to FIG. 19(a) to FIG. 19(e). FIG. 19(a) to FIG. 19(e) are diagrams of a control of at least one first application window according to an embodiment of this application. There are diagrams FIG. 19(a), FIG. 19(b), FIG. 19(c), FIG. 19(d), and FIG. 19(e). FIG. 19(a) may be understood with reference to the right sub-diagram of FIG. 18. Both the sub-diagrams show that the application window 1 is switched from being displayed on the second display screen to being displayed on the first display screen. When the user inputs a tap operation in any region, in all regions included in the first display screen, different from a region occupied by the control of the at least one first application window, entering FIG. 19(b) may be triggered. The first display screen displays a second icon corresponding to the control of the at least one first application window, and the input control on the first display screen is closed.

In FIG. 19(c), when the user taps the second icon, entering FIG. 19(d) may be triggered, to expand the control of the at least one first application window (that is, display the control of the at least one first application window in the first displayed state) on the first display screen, and display the thumbnail of each input control (that is, the keyboard and the touchpad). When the user taps the thumbnail of the touchpad, entering FIG. 19(e) is triggered, to display the thumbnail of the keyboard and the touchpad on the first display screen, and the first application window displayed on the first display screen automatically collapses. It should be understood that the example in FIG. 19(a) to FIG. 19(e) is merely for ease of understanding of this solution, and is not intended to limit this solution.

Optionally, when the target application window (that is, any one of the at least one first application window) is displayed on the first display screen, the control of the target application window uses a first display manner. When the target application window is displayed on the second display screen, the control of the target application window uses a second display manner. The first display manner is different from the second display manner.

For example, a difference between the first display manner and the second display manner may be as follows: A visual display angle of the first display manner is different from a visual display angle of the second display manner, or transparency of the first display manner is different from transparency of the second display manner, or there may be another difference between the first display manner and the second display manner, or the like. It should be noted that the example herein is merely used to prove implementability of this solution. Details may be flexibly determined with reference to an actual application scenario. This is not limited in embodiments of this application.

Optionally, when the target application window is displayed on the first display screen, in a process in which the electronic device obtains an upward slide operation input by the user by using the control of the target application window, the control of the target application window may change in real time, so that the control of the target application window can gradually change from the first display manner to the second display manner. When the target application window is displayed on the second display screen, in a process in which the electronic device obtains a downward slide operation input by the user by using the control of the target application window, the control of the target application window may change in real time, so that the control of the target application window can gradually change from the second display manner to the first display manner.

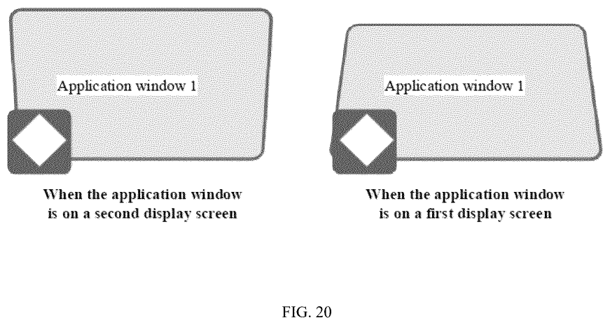

For more intuitive understanding of this solution, refer to FIG. 20. FIG. 20 is another diagram of a control of at least one first application window according to an embodiment of this application. In FIG. 20, an example in which a target application window (that is, any first application window in the at least one first application window) is an application window 1 is used. FIG. 20 includes two sub-diagrams: a left sub-diagram and a right sub-diagram. When the application window 1 is displayed on the second display screen, referring to the left sub-diagram of FIG. 20, a visual display angle of a control of the application window 1 may be parallel to the first display screen. When the application window 1 is displayed on the first display screen, referring to the right sub-diagram of FIG. 20, a visual display angle of the control of the application window 1 may have an included angle with the first display screen. It can be learned from comparison between the left sub-diagram and the right sub-diagram of FIG. 20 that when the application window 1 is displayed on the second display screen and the first display screen, the visual display angles of the control of the application window 1 are different. It should be understood that the example in FIG. 20 is merely for ease of understanding of this solution, and is not intended to limit this solution.

In this embodiment of this application, in the two cases in which the first application window is located on the first display screen and the second display screen, the control of the first application window may use different display manners, so that when viewing the control of each first application window, the user can learn whether each first application window is located on the first display screen or the second display screen, thereby helping the user manage the application window more efficiently.

In another application scenario, the second operation is adjusting a display position of the first application window on a same display screen. For example, in a case, when the first operation is a leftward slide operation obtained by using the control of the first application window, the second operation is displaying the first application window in a left region of a current display screen, where the current display screen is a display screen that displays the first application window before the first operation is obtained; or when the first operation is a rightward slide operation obtained by using the control of the first application window, the second operation is displaying the first application window in a right region of the current display screen.

For example, the left region of the current display screen may be understood as a region of a left half display screen of the current display screen, and the right region of the current display screen may be understood as a region of a right half display screen of the current display screen. Then, when the first operation is a leftward slide operation obtained by using the control of the first application window, the second operation may be understood as controlling the first application window to perform screen splitting on a left side. When the first operation is a rightward slide operation obtained by using the control of the first application window, the second operation may be understood as controlling the first application window to perform screen splitting on a right side.

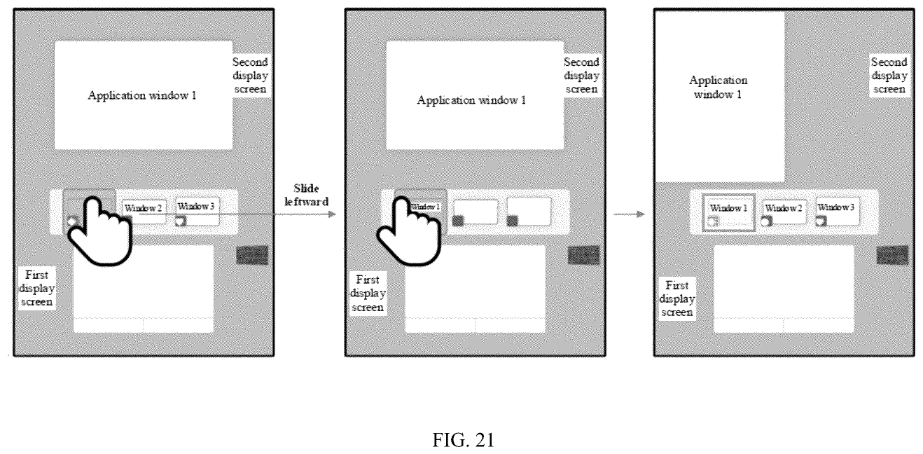

For more intuitive understanding of this solution, refer to FIG. 21. FIG. 21 is a diagram of adjusting a position of a first application window according to an embodiment of this application. In FIG. 21, an example in which a control of an application window 1 is used to control displaying of the application window 1 in a left region of a current display screen is used. FIG. 21 includes three sub-diagrams: a left sub-diagram, a middle sub-diagram, and a right sub-diagram. The left sub-diagram and the right sub-diagram of FIG. 21 show a leftward slide operation input by the user for the control of the application window 1. When the electronic device obtains a leftward slide operation by using the control of the application window 1, entering the right sub-diagram of FIG. 21 may be triggered. The application window 1 is displayed in a region of a left half display screen of the second display screen. It should be understood that the example in FIG. 21 is merely for ease of understanding of this solution, and is not intended to limit this solution.

In this embodiment of this application, the user may input a leftward slide operation or a rightward slide operation on the control of the first application window, so that a position of the first application window can be adjusted to the left region or the right region of the current display screen. This operation is simple, and the foregoing implementation is very efficient.

In another case, when the first operation includes obtaining a touch-and-hold operation and a movement gesture by using a control of a first application window, the second operation includes controlling the first application window to perform a movement operation corresponding to the movement gesture. Optionally, a movement direction of the first application window may be consistent with a movement direction of the movement gesture, and a movement distance of the first application window is corresponding to a movement distance of the movement gesture.

It should be noted that “the touch-and-hold operation for the control of the first application window” may be replaced with “a double-tap operation for the control of the first application window”, or may be replaced with “a circle gesture input in a region occupied by the control of the first application window”, another operation input for the first application window, or the like. Details may be flexibly set with reference to an actual application scenario. This is not limited in embodiments of this application.

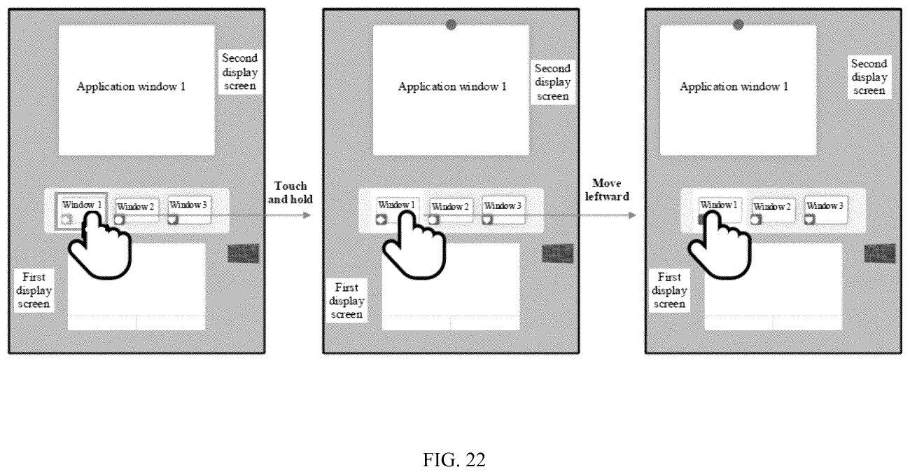

For more intuitive understanding of this solution, refer to FIG. 22. FIG. 22 is another diagram of adjusting a position of a first application window according to an embodiment of this application. FIG. 22 includes three sub-diagrams: a left sub-diagram, a middle sub-diagram, and a right sub-diagram. In the left sub-diagram of FIG. 22, after the user inputs a touch-and-hold operation on a control of an application window 1 (that is, an example of a first application window), entering the middle sub-diagram of FIG. 22 is triggered, that is, the application window 1 is triggered to enter a drag mode. In the right sub-diagram of FIG. 22, if the user keeps a pressed state of the control of the application window 1 and moves the control leftward, the application window 1 also moves leftward. A distance by which the application window 1 moves leftward is corresponding to a distance by which the user moves the control leftward. It should be understood that the example in FIG. 22 is merely for ease of understanding of this solution, and is not intended to limit this solution.

In this embodiment of this application, after touching and holding the control of the first application window, the user only needs to input a drag gesture on the control of the first application window, so as to control, based on the drag gesture input by the user, the first application window to move. In this way, the user can control, based on a requirement of the user, the first application window to move to any position of the current display screen, thereby greatly improving flexibility of the user in a process of moving the first application window.

In another application scenario, if only one application window can be displayed on a same display screen of the electronic device at a time, the second operation may alternatively be a pin operation of the display position of the first application window on the display screen. For example, when a first application window is displayed on the first display screen, and the first operation is a downward slide operation obtained by using a control of the first application window, the second operation is triggering the first application window to be displayed on the first display screen in a pinned state. That the first application window is displayed on the first display screen in a pin (pin) state represents that when another application window is displayed on the first display screen, the first application window is not collapsed; or
when a first application window is displayed on the second display screen, and the first operation is an upward slide operation obtained by using a control of the first application window, the second operation is triggering the first application window to be displayed on the second display screen in a pinned state. That the first application window is displayed on the second display screen in a pinned state represents that when another application window is displayed on the second display screen, the first application window is not collapsed.

Optionally, if a pinned state of a first application window needs to be canceled, in an implementation, a control of the first application window may be used to control the first application window to switch from being displayed to being collapsed. When the first application window is collapsed, the pinned state of the first application window is automatically canceled. In another implementation, the first application window may be further switched from being displayed on the first display screen to being displayed on the second display screen by using the control of the first application window, or the first application window may be switched from being displayed on the second display screen to being displayed on the first display screen by using the control of the first application window. When a display screen on which the first application window is located changes, the pinned state of the first application window is automatically canceled, and so on. Alternatively, a pinned state of a first application window may be canceled in another manner. The example herein is merely used to prove implementability of this solution, and is not intended to limit this solution.

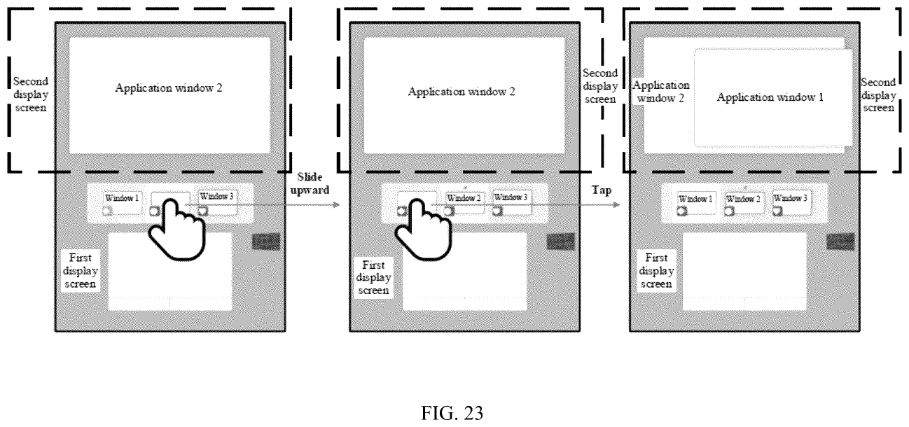

For more intuitive understanding of this solution, refer to FIG. 23. FIG. 23 is another diagram of adjusting a position of a first application window according to an embodiment of this application. FIG. 23 includes three sub-diagrams: a left sub-diagram, a middle sub-diagram, and a right sub-diagram. In the left sub-diagram of FIG. 23, the application window 2 is displayed on the second display screen. If the user wants to display the application window 2 on the second display screen in a pinned state, and does not want to collapse the application window 2 when another application window is displayed on the second display screen, the user may input an upward slide operation on the control of the application window 2, to trigger entering the middle sub-diagram of FIG. 23.

In the middle sub-diagram of FIG. 23, the application window 2 is displayed on the second display screen in a pinned state. After the user inputs a tap operation on the control of the application window 1, entering the right sub-diagram of FIG. 23 is triggered. In the right sub-diagram of FIG. 23, when the application window 1 is displayed on the second display screen in a pin on top manner, the application window 2 in a pinned state is not collapsed, but is displayed on the second display screen in an unpin on top manner. It should be understood that the example in FIG. 23 is merely for ease of understanding of this solution, and is not intended to limit this solution.

In this embodiment of this application, by using the foregoing solution, a plurality of application windows can be displayed on a same display screen, so that a case in which only one application window can be displayed on a same display screen is avoided. To be specific, the user can control the application window more flexibly.

In another application scenario, the second operation is adjusting a size of the first application window. Optionally, when the first operation is any one of the following operations: a double-tap operation, a dual-finger pinch operation, or a dual-finger spread operation, the second operation includes controlling the first application window to switch between the following plurality of display manners: displaying the first application window in a maximized manner on a current display screen, where the current display screen is a display screen that displays the first application window before the first operation is obtained; displaying the first application window in a maximized manner on two display screens of the electronic device; or displaying the first application window in a third display manner, where the third display manner is a display manner of the first application window before the first operation is obtained.

For example, if the target application window (that is, any one of the at least one first application window) is being displayed on a current display screen in the third display manner, the electronic device obtains a dual-finger spread operation input on the control of the target application window, and switching to displaying the target application window in a maximized manner on the current display screen may be triggered. When the electronic device obtains again a dual-finger spread operation input on the control of the target application window, switching to displaying the target application window in a maximized manner on two display screens of the electronic device may be triggered. When the electronic device obtains again a dual-finger spread operation input on the control of the target application window, switching to displaying the target application window on the current display screen in the third display manner may be triggered. It should be understood that the example herein is merely for ease of understanding of this solution, and is not intended to limit this solution.

Optionally, when the first application window is displayed in a maximized manner on the two display screens of the electronic device, the control of the at least one first application window may be displayed on the second display screen in the second displayed state.

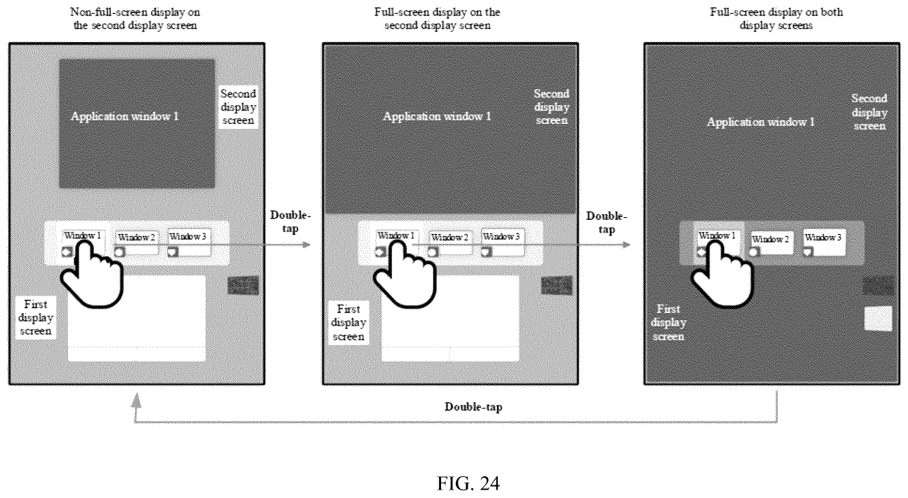

For more intuitive understanding of this solution, refer to FIG. 24. FIG. 24 is a diagram of adjusting a size of a first application window according to an embodiment of this application. FIG. 24 includes three sub-diagrams: a left sub-diagram, a middle sub-diagram, and a right sub-diagram. In the left sub-diagram of FIG. 24, the application window 1 is displayed on the second display screen in a non-full-screen display manner. The user double-taps the control of the application window 1, to trigger entering the middle sub-diagram of FIG. 24. The application window 1 is displayed in a maximized manner on a current display screen (the second display screen is used as an example in FIG. 24). When the user double-taps the control of the application window 1 again, entering the right sub-diagram of FIG. 24 is triggered, and the application window 1 is displayed in a maximized manner on two display screens of the electronic device. When the user double-taps the control of the application window 1 again, entering the left sub-diagram of FIG. 24 again is triggered, the application window 1 is displayed on the second display screen in a non-full-screen display manner again, and the application window 1 restores to an initial size and position. This process repeats cyclically. It should be understood that the example in FIG. 24 is merely for ease of understanding of this solution, and is not intended to limit this solution.

In this embodiment of this application, when the user inputs a double-tap operation, a dual-finger pinch operation, or a dual-finger spread operation by using the control of the first application window, the first application window can be triggered to switch in three display manners with different sizes, thereby implementing quick and convenient adjustment of the size of the first application window.

Optionally, when a desktop of the electronic device is displayed in a maximized manner on two display screens of the electronic device, and the control of the at least one first application window is displayed on the first display screen, at least one icon included on the desktop is located in the second display screen.

Optionally, when the desktop of the electronic device is displayed in a maximized manner on the two display screens of the electronic device, and the first display screen does not display the control of the first application window and the input control; or when the desktop of the electronic device is displayed in a maximized manner on the two display screens of the electronic device, and the control of the first application window is displayed in the second display form on the first display screen, the at least one icon included on the desktop may fully fill the two display screens of the electronic device.

In this embodiment of this application, the at least one icon included on the desktop is located only on the second display screen, thereby avoiding a case in which the icon on the desktop cannot be tapped because the control of the first application window blocks the icon, and ensuring that both the icon on the desktop and the control of the first application window can be normally used.

The control of each application window is displayed at the top of the first display screen, and the user input an operation for the application window by using the control of the first application window located at the top of the first display screen, and the user does not need to raise a hand to tap the second display screen. This not only avoids fatigue of the user, but also avoids shaking or even tip-over of the second display screen. In addition, because the control of the application window is disposed at the top of the first display screen, the user can see the control of the application window without a need to lower the head, thereby avoiding burden on the cervical vertebra of the user, and helping further enhance user viscosity of this solution.

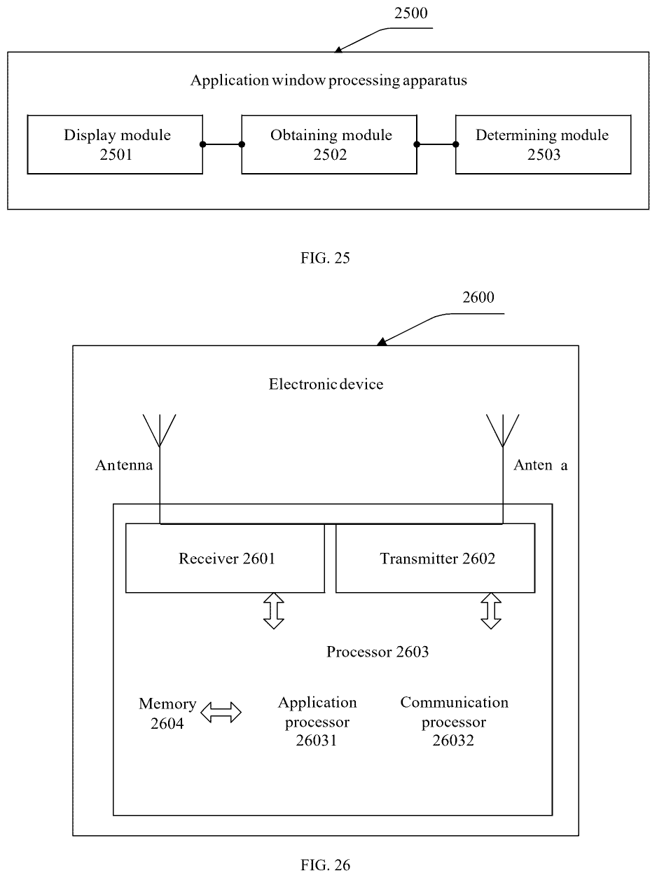

Based on the embodiments corresponding to FIG. 1 to FIG. 24, to better implement the foregoing solutions in embodiments of this application, the following further provides related devices configured to implement the foregoing solutions. Specifically, refer to FIG. 25. FIG. 25 is a diagram of a structure of an application window processing apparatus according to an embodiment of this application. The application window processing apparatus 2500 includes: a display module 2501, configured to display a control of at least one first application window at a top of the first display screen, where the top of the first display screen is a region that is in the first display screen and that is close to a second display screen, and each first application window is in an enabled state on the first display screen or the second display screen; an obtaining module 2502, configured to obtain a first operation by using the control of the first application window; and a determining module 2503, configured to determine a second operation for the first application window in response to the first operation.

Optionally, when the control of the at least one first application window and an input control are displayed on the first display screen, the control of the at least one first application window is located on an upper side of the input control, and the input control includes a keyboard and/or a touchpad.

Optionally, a factor that triggers adjustment of an area occupied by the control of the at least one first application window includes: the input control is switched between a first display mode and a second display mode; and both the keyboard and the touchpad are displayed in the first display mode, with the touchpad on an upper side or a lower side of the keyboard, and the second display mode is any one of the following plurality of display modes: displaying a thumbnail of the touchpad and the keyboard, displaying a thumbnail of the keyboard and the touchpad, or displaying both the keyboard and the touchpad, with the touchpad on a left side or a right side of the keyboard.

Optionally, a mode of displaying the input control on the first display screen includes any one or more of the following: displaying the thumbnail of the touchpad and the keyboard; displaying the thumbnail of the keyboard and the touchpad; displaying the thumbnail of the touchpad and the thumbnail of the keyboard; displaying both the keyboard and the touchpad, with the touchpad on a left side or a right side of the keyboard; or displaying both the keyboard and the touchpad, with the touchpad on the upper side or the lower side of the keyboard.

Optionally, when the control of the at least one first application window is in a first displayed state, the control of the first application window includes a thumbnail of the first application window and/or a first icon of an application program corresponding to the first application window.

Optionally, when the control of the at least one first application window is in a second displayed state, a second icon corresponding to the control of the at least one first application window is displayed on the first display screen, the second icon is used to obtain a third operation, and the third operation is used to switch the control of the at least one first application window from the second displayed state to the first displayed state.

Optionally, when the first application window is displayed on the first display screen, the control of the first application window uses a first display manner, or when the first application window is displayed on the second display screen, the control of the first application window uses a second display manner, where the first display manner is different from the second display manner.

Optionally, when the at least one first application window is displayed on the first display screen, a thumbnail of an input control is displayed on the first display screen, where the input control includes a keyboard and/or a touchpad.

Optionally, the second operation is any one of the following operations: switching the first application window from being collapsed to being displayed; switching the first application window from being displayed on the first display screen to being displayed on the second display screen; switching the first application window from being displayed on the second display screen to being displayed on the first display screen; adjusting a display position of the first application window on a same display screen; or adjusting a size of the first application window.

Optionally, when the first application window is displayed on the second display screen, and the first operation is a downward slide operation obtained by using the control of the first application window, the second operation is switching the first application window from being displayed on the second display screen to being displayed on the first display screen; or when the first application window is displayed on the first display screen, and the first operation is an upward slide operation obtained by using the control of the first application window, the second operation is switching the first application window from being displayed on the first display screen to being displayed on the second display screen.

Optionally, when the first operation is a leftward slide operation obtained by using the control of the first application window, the second operation is displaying the first application window in a left region of a current display screen, where the current display screen is a display screen that displays the first application window before the first operation is obtained; or when the first operation is a rightward slide operation obtained by using the control of the first application window, the second operation is displaying the first application window in a right region of the current display screen.

Optionally, when the first operation includes obtaining a touch-and-hold operation and a movement gesture by using the control of the first application window, the second operation includes controlling the first application window to perform a movement operation corresponding to the movement gesture.

Optionally, when the first operation is any one of the following operations: a double-tap operation, a dual-finger pinch operation, or a dual-finger spread operation, the second operation includes controlling the first application window to switch between the following plurality of display manners: displaying the first application window in a maximized manner on a current display screen, where the current display screen is a display screen that displays the first application window before the first operation is obtained; displaying the first application window in a maximized manner on two display screens of the electronic device; or displaying the first application window in a third display manner, where the third display manner is a display manner of the first application window before the first operation is obtained.

Optionally, when the first application window is displayed on the first display screen, and the first operation is a downward slide operation obtained by using the control of the first application window, the second operation is triggering the first application window to be displayed on the first display screen in a pinned state, and that the first application window is displayed on the first display screen in a pinned state represents that when another application window is displayed on the first display screen, the first application window is not collapsed; or when the first application window is displayed on the second display screen, and the first operation is an upward slide operation obtained by using the control of the first application window, the second operation is triggering the first application window to be displayed on the second display screen in a pinned state, and that the first application window is displayed on the second display screen in a pinned state represents that when another application window is displayed on the second display screen, the first application window is not collapsed.

Optionally, when a desktop of the electronic device is displayed in a maximized manner on two display screens of the electronic device, and the control of the at least one first application window is displayed on the first display screen, at least one icon included on the desktop is located in the second display screen.

It should be noted that content such as information exchange and an execution process between the modules/units in the application window processing apparatus 2500 is based on a same concept as the method embodiments corresponding to FIG. 3 to FIG. 24 in this application. For specific content, refer to the descriptions in the foregoing method embodiments in this application. Details are not described herein again.

The following describes an electronic device according to an embodiment of this application. FIG. 26 is a diagram of a structure of an electronic device according to an embodiment of this application. Specifically, an electronic device 2600 includes a receiver 2601, a transmitter 2602, a processor 2603, and a memory 2604 (there may be one or more processors 2603 in the electronic device 2600, and one processor is used as an example in FIG. 26). The processor 2603 may include an application processor 26031 and a communication processor 26032. In some embodiments of this application, the receiver 2601, the transmitter 2602, the processor 2603, and the memory 2604 may be connected through a bus or in another manner.

The memory 2604 may include a read-only memory and a random access memory, and provide instructions and data to the processor 2603. A part of the memory 2604 may further include a non-volatile random access memory (non-volatile random access memory, NVRAM). The memory 2604 stores operation instructions of the processor, executable modules, or data structures, or subsets thereof, or extended sets thereof, where the operation instructions may include various operation instructions for implementing various operations.

The processor 2603 controls an operation of the electronic device. During specific application, components of the electronic device are coupled together through a bus system. In addition to a data bus, the bus system may further include a power bus, a control bus, a status signal bus, and the like. However, for clear description, various types of buses in the figure are marked as the bus system.

The methods disclosed in the foregoing embodiments of this application may be applied to the processor 2603, or implemented by the processor 2603. The processor 2603 may be an integrated circuit chip having a signal processing capability. In an implementation process, the steps of the foregoing methods may be completed by a hardware integrated logic circuit or instructions in the form of software in the processor 2603. The processor 2603 may be a general-purpose processor, a digital signal processor (digital signal processor, DSP), a microprocessor or a microcontroller. The processor 2603 may further include an application-specific integrated circuit (application-specific integrated circuit, ASIC), a field programmable gate array (field programmable gate array, FPGA) or another programmable logic device, a discrete gate or transistor logic device, or a discrete hardware component. The processor 2603 can implement or execute various methods, steps, and logical block diagrams disclosed in the embodiments of this application. The general-purpose processor may be a microprocessor, or the processor may be any conventional processor or the like. Steps of the methods disclosed with reference to embodiments of this application may be directly executed and accomplished by using a hardware decoding processor, or may be executed and accomplished by using a combination of hardware and software modules in the decoding processor. A software module may be located in a mature storage medium in the art, such as a random access memory, a flash memory, a read-only memory, a programmable read-only memory, an electrically erasable programmable memory, or a register. The storage medium is located in the memory 2604, and the processor 2603 reads information in the memory 2604 and completes the steps in the foregoing methods in combination with hardware of the processor 2603.

The receiver 2601 may be configured to receive input digital or character information, and generate a signal input related to related settings and function control of the electronic device. The transmitter 2602 may be configured to output digital or character information through a first interface. The transmitter 2602 may be further configured to send instructions to a disk group through the first interface, to modify data in the disk group. The transmitter 2602 may further include a display device such as a display screen.

In this embodiment of this application, the processor 2603 is configured to perform the application window processing method performed by the electronic device in the embodiments corresponding to FIG. 3 to FIG. 24. It should be noted that a specific manner in which the application processor 26031 in the processor 2603 performs the foregoing steps is based on a same concept as the method embodiments corresponding to FIG. 3 to FIG. 24 in this application. Technical effects brought by the specific manner are the same as those in the method embodiments corresponding to FIG. 3 to FIG. 24 in this application. For specific content, refer to the descriptions in the foregoing method embodiments in this application. Details are not described herein again.

An embodiment of this application further provides a computer-readable storage medium. The computer-readable storage medium stores a program used for signal processing. When the program runs on a computer, the computer is enabled to perform the steps performed by the electronic device in the method described in the embodiments shown in FIG. 3 to FIG. 24.

An embodiment of this application further provides a computer program product. The computer program product includes instructions. When the instructions run on a computer, the computer is enabled to perform the steps performed by the electronic device in the methods described in the embodiments shown in FIG. 3 to FIG. 24.

The electronic device provided in embodiments of this application may be specifically a chip. The chip includes a processing unit and a communication unit. The processing unit may be, for example, a processor, and the communication unit may be, for example, an input/output interface, a pin, or a circuit. The processing unit may execute computer-executable instructions stored in a storage unit, so that the chip performs the method described in the embodiments shown in FIG. 3 to FIG. 24. Optionally, the storage unit is a storage unit in the chip, for example, a register or a cache. Alternatively, the storage unit may be a storage unit in a wireless access device end but outside the chip, for example, a read-only memory (read-only memory, ROM), another type of static storage device that can store static information and instructions, or a random access memory (random access memory, RAM).

The processor mentioned above may be a general-purpose central processing unit, a microprocessor, an ASIC, or one or more integrated circuits that are configured to control program execution of the method according to the first aspect.

In addition, it should be noted that the described apparatus embodiment is merely an example. The units described as separate parts may or may not be physically separate, and parts displayed as units may or may not be physical units, may be located in one position, or may be distributed on a plurality of network units. Some or all the modules may be selected according to actual needs to achieve the objectives of the solutions of embodiments. In addition, in the accompanying drawings of the apparatus embodiments provided by this application, connection relationships between modules indicate that the modules have communication connections with each other, which may be specifically implemented as one or more communications buses or signal cables.

Based on the description of the foregoing implementations, a person skilled in the art may clearly understand that this application may be implemented by software in addition to necessary universal hardware, or by dedicated hardware, including a dedicated integrated circuit, a dedicated CPU, a dedicated memory, a dedicated component, and the like. Generally, any functions that can be performed by a computer program can be easily implemented by using corresponding hardware. Moreover, a specific hardware structure used to achieve a same function may be in various forms, for example, in a form of an analog circuit, a digital circuit, or a dedicated circuit. However, as for this application, software program implementation is a better implementation in most cases. Based on such an understanding, the technical solutions of this application essentially or the part contributing to the prior art may be implemented in a form of a software product. The computer software product is stored in a readable storage medium, such as a floppy disk, a USB flash drive, a removable hard disk, a ROM, a RAM, a magnetic disk, or an optical disc of a computer, and includes several instructions for instructing a computer device (which may be a personal computer, a training device, a network device, or the like) to perform the methods in embodiments of this application.

All or some of the foregoing embodiments may be implemented by using software, hardware, firmware, or any combination thereof. When software is used to implement the embodiments, all or a part of the embodiments may be implemented in a form of a computer program product.

The computer program product includes one or more computer instructions. When the computer program instructions are loaded and executed on the computer, all or some of the procedures or functions according to the embodiments of this application are generated. The computer may be a general-purpose computer, a dedicated computer, a computer network, or other programmable apparatuses. The computer instructions may be stored in a computer-readable storage medium, or may be transmitted from a computer-readable storage medium to another computer-readable storage medium. For example, the computer instructions may be transmitted from a website, a computer, a training device, or a data center to another website, computer, training device, or data center in a wired (for example, a coaxial cable, an optical fiber, or a digital subscriber line (DSL)) or wireless (for example, infrared, radio, or microwave) manner. The computer-readable storage medium may be any usable medium that can be stored by a computer, or a data storage device, such as a training device or a data center, integrating one or more usable media. The usable medium may be a magnetic medium (for example, a floppy disk, a hard disk, or a magnetic tape), an optical medium (for example, a DVD), a semiconductor medium (for example, a solid state drive (Solid State Disk, SSD)), or the like.

What is claimed is:

1. A method, wherein applied to an electronic device comprising a first display screen, and the method comprises:
displaying a control of at least one first application window at a top of the first display screen, wherein the top of the first display screen is a region that is in the first display screen and that is on a side of the first display screen that is closest to a second display screen, and each of the at least one first application window is in an enabled state on the first display screen or the second display screen;
obtaining a first operation through the control of the at least one first application window; and
determining a second operation for the first application window in response to the first operation.

2. The method according to claim 1, wherein when the control of the at least one first application window and an input control are displayed on the first display screen, the control of the at least one first application window is located on an upper side of the input control, and the input control comprises a keyboard or a touchpad.

3. The method according to claim 2, wherein:
a factor triggering adjustment of an area occupied by the control of the at least one first application window comprises: the input control is switched between a first display mode and a second display mode; and
both the keyboard and the touchpad are displayed in the first display mode, with the touchpad on an upper side or a lower side of the keyboard, and the second display mode comprises:
displaying a thumbnail of the touchpad and the keyboard;
displaying a thumbnail of the keyboard and the touchpad; or
displaying both the keyboard and the touchpad, with the touchpad on a left side or a right side of the keyboard.

4. The method according to claim 2, wherein a mode of displaying the input control on the first display screen comprises:
displaying a thumbnail of the touchpad and the keyboard;
displaying a thumbnail of the keyboard and the touchpad; or
displaying the thumbnail of the touchpad and the thumbnail of the keyboard.

5. The method according to claim 2, wherein a mode of displaying the input control on the first display screen comprises:
displaying both the keyboard and the touchpad, with the touchpad on a left side or a right side of the keyboard; or
displaying both the keyboard and the touchpad, with the touchpad on an upper side or a lower side of the keyboard.

6. The method according to claim 1, wherein when the control of the at least one first application window is in a first displayed state, the control of the first application window comprises a thumbnail of the first application window or a first icon of an application program corresponding to the first application window.

7. The method according to claim 6, wherein:
when the control of the at least one first application window is in a second displayed state, a second icon corresponding to the control of the at least one first application window is displayed on the first display screen, a third operation is obtained through the second icon, and the third operation switches the control of the at least one first application window from the second displayed state to the first displayed state.

8. The method according to claim 1, wherein:
when the first application window is displayed on the first display screen, the control of the first application window uses a first display manner; and
when the first application window is displayed on the second display screen, the control of the first application window uses a second display manner, wherein the first display manner is different from the second display manner.

9. The method according to claim 1, wherein when the at least one first application window is displayed on the first display screen, a thumbnail of an input control is displayed on the first display screen, wherein the input control comprises a keyboard or a touchpad.

10. The method according to claim 1, wherein the second operation comprises:
switching the first application window from being collapsed to being displayed;
switching the first application window from being displayed on the first display screen to being displayed on the second display screen;
switching the first application window from being displayed on the second display screen to being displayed on the first display screen;
adjusting a display position of the first application window on a same display screen; or
adjusting a size of the first application window.

11. The method according to claim 1, wherein:
when the first application window is displayed on the second display screen, and the first operation is a downward slide operation performed on the control of the first application window, the second operation is switching the first application window from being displayed on the second display screen to being displayed on the first display screen; and
when the first application window is displayed on the first display screen, and the first operation is an upward slide operation performed on the control of the first application window, the second operation is switching the first application window from being displayed on the first display screen to being displayed on the second display screen.

12. The method according to claim 1, wherein
when the first operation is a leftward slide operation performed on the control of the first application window, the second operation is displaying the first application window in a left region of a current display screen, wherein the current display screen is a display screen that displays the first application window before the first operation is obtained; and
when the first operation is a rightward slide operation performed on the control of the first application window, the second operation is displaying the first application window in a right region of the current display screen.

13. The method according to claim 1, wherein when the first operation comprises obtaining a touch-and-hold operation and a movement gesture performed on the control of the first application window, the second operation comprises controlling the first application window to perform a movement operation corresponding to the movement gesture.

14. The method according to claim 1, wherein when the first operation: a double-tap operation, a dual-finger pinch operation, or a dual-finger spread operation, the second operation comprises controlling the first application window to switch from a first display manner to a second display manner different from the first display manner, wherein the first display manner and the second display manner comprises:
displaying the first application window in a maximized manner on a current display screen, wherein the current display screen is a display screen that displays the first application window before the first operation is obtained;
displaying the first application window in a maximized manner on two display screens of the electronic device; or
displaying the first application window in a third display manner, wherein the third display manner is a display manner of the first application window before the first operation is obtained.

15. The method according to claim 1, wherein:
when the first application window is displayed on the first display screen, and the first operation is a downward slide operation performed on the control of the first application window, the second operation is triggering the first application window to be displayed on the first display screen in a pinned state, and that the first application window is displayed on the first display screen in the pinned state represents that when another application window is displayed on the first display screen, the first application window is not collapsed; and
when the first application window is displayed on the second display screen, and the first operation is an upward slide operation performed on the control of the first application window, the second operation is triggering the first application window to be displayed on the second display screen in a pinned state, and that the first application window is displayed on the second display screen in the pinned state represents that when another application window is displayed on the second display screen, the first application window is not collapsed.

16. The method according to claim 1, wherein when a desktop of the electronic device is displayed in a maximized manner on two display screens of the electronic device, and the control of the at least one first application window is displayed on the first display screen, at least one icon comprised on the desktop is located in the second display screen.

17. An apparatus, comprising:
a display configured to display a control of at least one first application window at a top of a first display screen, wherein the top of the first display screen is a region that is in the first display screen and that is on a side of the first display screen that is closest to a second display screen, and each of the at least one first application window is in an enabled state on the first display screen or the second display screen;
at least one non-transitory memory storage comprising instructions; and
one or more processors in communication with the memory storage, wherein the one or more processors execute the instructions to:
obtain a first operation through the control of the at least one first application window; and
determine a second operation for the at least one first application window in response to the first operation.

18. An electronic device, comprising:
at least one processor; and
a non-transitory computer readable medium which contains computer-executable instructions, wherein the processor is configured to execute the computer-executable instructions to perform:
displaying a control of at least one first application window at a top of a first display screen, wherein the top of the first display screen is a region that is in the first display screen and that is on a side of the first display screen that is closest to a second display screen, and each of the at least one first application window is in an enabled state on the first display screen or the second display screen;
obtaining a first operation by using the control of the at least one first application window; and
determining a second operation for the first application window in response to the first operation.

19. A non-transitory computer readable medium which contains computer-executable instructions, wherein the computer-executable instructions, when executed by a processor, enables a first network device to perform:
displaying a control of at least one first application window at a top of a first display screen, wherein the top of the first display screen is a region that is in the first display screen and that is on a side of the first display screen that is closest to a second display screen, and each of the at least one first application window is in an enabled state on the first display screen or the second display screen; and
obtaining a first operation through the control of the at least one first application window; and
determining a second operation for the at least one first application window in response to the first operation.
